(19) United States
(12) Patent Application Publication
(10) Pub. No.: US 2015/0356936 A1
(43) Pub. Date: Dec. 10, 2015

(54) LIQUID CRYSTAL DISPLAY DEVICE

(71) Applicant: Japan Display Inc., Minato-ku (JP)

(72) Inventors: Yukio TANAKA, Kanazawa-shi (JP); Daiichi SUZUKI, Nonoichi-shi (JP); Kenji NAKAO, Kanazawa-shi (JP)

(73) Assignee: Japan Display Inc., Minato-ku (JP)

(21) Appl. No.: 14/828,103

(22) Filed: Aug. 17, 2015

Related U.S. Application Data
(62) Division of application No. 13/668,642, filed on Nov. 5, 2012.

(30) Foreign Application Priority Data
Nov. 7, 2011 (JP) 2011-243647

(51) Int. Cl. G09G 3/36

(52) U.S. Cl. CPC G09G 3/3614; G09G 3/3655; G09G 3/3677; G09G 3/3688; G09G 3/3696; G09G 2310/0254; G09G 2300/0823; G09G 2310/0202

(57) ABSTRACT

According to one embodiment, a display device includes an array substrate including pixel electrodes arranged in a matrix, gate lines and auxiliary capacitance lines extending a first direction, signal lines extending a second direction, and a driving circuit configured to drive the gate lines, the signal lines, and the auxiliary capacitance lines, a counter substrate arranged opposite the array substrate, a liquid crystal layer held between the substrates, and a controller configured to control the driving circuit in such a manner that a polarity of a signal supplied to each of the signal lines varies in units of horizontal periods during a frame period when the polarity control signal for the first scan is identical to the polarity control signal for the second scan.

### CROSS-REFERENCE TO RELATED APPLICATIONS

This application is based upon and claims the benefit of priority from Japanese Patent Application No. 2011-243647, filed Nov. 7, 2011, the entire contents of which are incorporated herein by reference.

### FIELD

Embodiments described herein relate generally to a liquid crystal display device and a method for driving the liquid crystal display device.

### BACKGROUND

A liquid crystal display device comprises a pair of substrates, a liquid crystal layer sandwiched between the pair of substrates, and a display area formed of a plurality of display pixels.

The liquid crystal display device carries out alternating field driving to invert the polarity of a liquid crystal application voltage at intervals of one or more scan lines in order to prevent a possible flicker. When only one of the polarity inversion at intervals of one or more scan lines and the polarity inversion at intervals of one or more signal lines is carried out, a flicker may be viewed along a direction in which the scan lines or the signal lines extend. Thus, high-image-quality liquid crystal display devices may adopt dot inversion driving in which the polarity is inverted both at intervals of one or more scan lines and at intervals of one or more signal lines.

On the other hand, as a method for reducing signal voltage amplitude, capacitively-coupled (CC) driving has been proposed. In the capacitively-coupled driving a driver superimposes an auxiliary capacitance signal on a pixel electrode by a coupled auxiliary capacitance so that the pixel electrode reaches a predetermined voltage. The adoption of the capacitively-coupled driving enables the signal voltage amplitude to be approximately halved when auxiliary capacitance is set substantially equal to pixel capacitance.

A required specification for a liquid crystal display device mounted in an electronic apparatus such as a cell phone or a smartphone is such that screen display is compatible with vertical inversion display. Thus, there is a demand to allow the liquid crystal display device to provide normal display regardless of whether the scan proceeds in an up-down direction (up-down scan) or in a down-up direction (down-up scan).

The direction in which the signal lines extend is hereinafter referred to as the “up-down direction” regardless of a manner in which the liquid crystal display device is placed during use (vertically placed or horizontally placed). In the up-down direction, one side is referred to as “up”, while the opposite side is referred to as “down”.

### BRIEF DESCRIPTION OF THE DRAWINGS

FIG. 1 is a diagram schematically showing an example of a configuration of a liquid crystal display device according to an embodiment;

FIG. 2 is a diagram showing an example of a circuit block in a Y driver in the liquid crystal display device shown in FIG. 1;

FIG. 3A is a timing chart illustrating an example of a driving method that is used when the liquid crystal display device according to the embodiment carries out an up-down scan;

FIG. 3B is a timing chart illustrating an example of a driving method that is used when the liquid crystal display device according to the embodiment carries out a down-up scan;

FIG. 4A is a timing chart illustrating an example of a driving method that is used when a liquid crystal display device adapted for 1H1V-CCDI driving carries out an up-down scan;

FIG. 4B is a timing chart illustrating an example of a driving method that is used when the liquid crystal display device adapted for the 1H1V-CCDI driving carries out an up-down scan;

FIG. 4C is a timing chart illustrating an example of a driving method that is used when the liquid crystal display device adapted for the 1H1V-CCDI driving carries out a down-up scan;

FIG. 4D is a timing chart illustrating an example of a driving method that is used when the liquid crystal display device adapted for the 1H1V-CCDI driving carries out a down-up scan;

FIG. 5A is a timing chart illustrating an example of a driving method that is used when a liquid crystal display device adapted for 2H1V-CCDI driving carries out an up-down scan;

FIG. 5B is a timing chart illustrating an example of a driving method that is used when the liquid crystal display device adapted for the 2H1V-CCDI driving carries out an up-down scan;

FIG. 5C is a timing chart illustrating an example of a driving method that is used when the liquid crystal display device adapted for the 2H1V-CCDI driving carries out a down-up scan;

FIG. 5D is a timing chart illustrating an example of a driving method that is used when the liquid crystal display device adapted for the 2H1V-CCDI driving carries out a down-up scan;

FIG. 5E is a timing chart illustrating an example of a driving method that is used when the liquid crystal display device adapted for the 2H1V-CCDI driving carries out a down-up scan;

FIG. 5F is a timing chart illustrating an example of a driving method that is used when the liquid crystal display device adapted for the 2H1V-CCDI driving carries out a down-up scan;

FIG. 5G is a timing chart illustrating an example of a driving method that is used when the liquid crystal display device adapted for the 2H1V-CCDI driving carries out a down-up scan;

FIG. 5H is a timing chart illustrating an example of a driving method that is used when the liquid crystal display device adapted for the 2H1V-CCDI driving carries out a down-up scan;

FIG. 5I is a timing chart illustrating an example of a driving method that is used when the liquid crystal display device adapted for the 2H1V-CCDI driving carries out a down-up scan;

FIG. 5J is a timing chart illustrating an example of a driving method that is used when the liquid crystal display device adapted for the 2H1V-CCDI driving carries out a down-up scan;

FIG. 6A is a timing chart illustrating an example of a driving method that is used when a liquid crystal display device adapted for CC column inversion driving carries out an up-down scan;

FIG. 6B is a timing chart illustrating an example of a driving method that is used when the liquid crystal display device adapted for the CC column inversion driving carries out an up-down scan;

FIG. 6C is a timing chart illustrating an example of a driving method that is used when the liquid crystal display device adapted for the CC column inversion driving carries out a down-up scan;

FIG. 6D is a timing chart illustrating an example of a driving method that is used when the liquid crystal display device adapted for the CC column inversion driving carries out a down-up scan;

FIG. 6E is a timing chart illustrating an example of a driving method that is used when the liquid crystal display device adapted for the CC column inversion driving carries out a down-up scan; and

FIG. 6F is a timing chart illustrating an example of a driving method that is used when the liquid crystal display device adapted for the CC column inversion driving carries out a down-up scan.

### DETAILED DESCRIPTION

In general, according to one embodiment, a liquid crystal display device comprises an array substrate comprising pixel electrodes arranged in a matrix, gate lines and auxiliary capacitance lines extending along rows each with the pixel electrodes arranged thereon, signal lines extending along columns each with the pixel electrodes arranged thereon, and a driving circuit configured to drive the gate lines, the signal lines, and the auxiliary capacitance lines; a counter substrate arranged opposite the array substrate; a liquid crystal layer held between the array substrate and the counter substrate; and a control circuit configured to supply a scan direction control signal switching between a first scan in which the gate lines arranged in a direction substantially parallel to a direction in which the signal lines extend and a second scan in which the gate lines are sequentially driven in a second direction opposite to the first direction and a polarity control signal controlling a polarity of a signal supplied to each of the auxiliary capacitance lines, and to be able to control the driving circuit in such a manner that a polarity of a signal supplied to each of the signal lines varies in units of horizontal periods during a frame period when the polarity control signal for the first scan is identical to the polarity control signal for the second scan.

The liquid crystal display device according to the embodiment will be described below in detail with reference to the drawings.

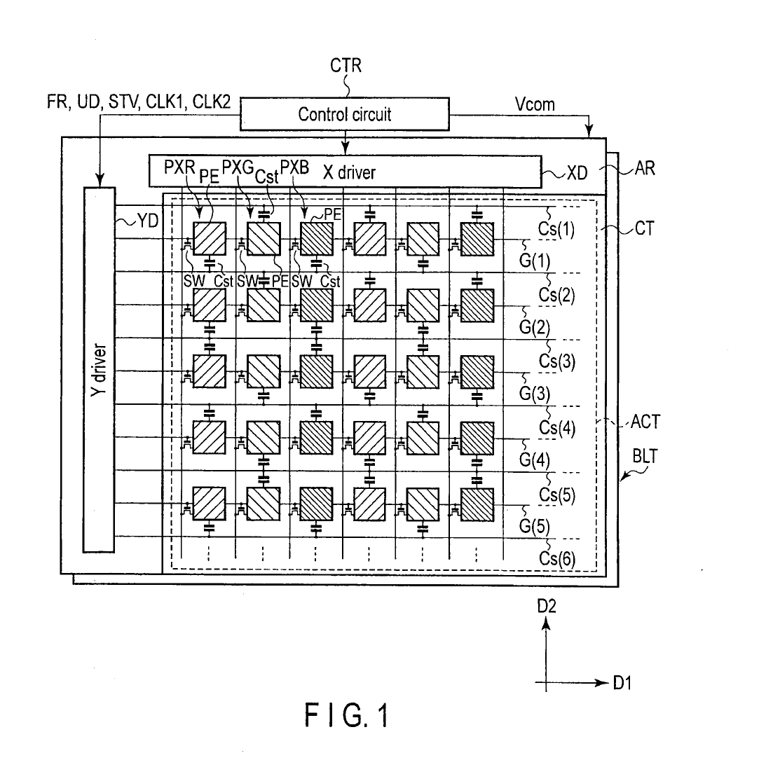

FIG. 1 is a diagram schematically showing an example of a configuration of the liquid crystal display device according to the embodiment. As shown in FIG. 1, the liquid crystal display device according to the embodiment comprises a liquid crystal display panel LPN with a display area ACT including a plurality of display pixels PX, a backlight BLT arranged to illuminate the display area ACT of the liquid crystal display panel, and a control circuit CTR that controls the liquid crystal display panel LPN and the backlight BLT.

The liquid crystal display panel LPN comprises a pair of substrates, that is, an array substrate AR and a counter substrate CT, and a liquid crystal layer (not shown in the drawings) sandwiched between the array substrate AR and the counter substrate CT. The liquid crystal display device according to the present embodiment adopts a square array as a pixel array. A plurality of display pixels PX are arranged in a matrix.

The liquid crystal display device according to the present embodiment is of a color display type. The plurality of display pixels PX include a plurality of color display pixels. The liquid crystal display device shown in FIG. 1 include red display pixels PXR that display red, green display pixels PXG that display green, and blue display pixels PXB that display blue.

The array substrate AR comprises, for example, a transparent insulating substrate (not shown in the drawings) such as glass. A plurality of pixel electrodes PE corresponding to the respective display pixels PX are arranged on the transparent insulating substrate. Moreover, the array substrate AR comprises a plurality of gate lines G (G(1) to G(M)) extending in a first direction D1 along rows in which the plurality of pixel electrodes PE are arranged, a plurality of signal lines S (S(1) to S(N)) extending in a second direction D2 along columns on which the plurality of pixel electrodes PE are arranged, auxiliary capacitance lines Cs (Cs(1) to Cs(M+1)) extending substantially parallel to the gate lines G, and a plurality of pixel switches SW each located in the vicinity of an intersecting position between the corresponding gate line G and signal line S.

Each of the pixel switches SW includes, for example, a thin film transistor (TFT) as a switching element. A gate of the pixel switch SW is electrically connected to the corresponding gate line G (or is integrated with the gate line G). A source of the pixel switch SW is electrically connected to the corresponding signal line S (or is integrated with the signal line S). A drain of the pixel switch SW is electrically connected to the corresponding pixel electrode PE (or is integrated with the pixel electrode PE). Each pixel switch SW, when driven via the corresponding gate line G, is made electrically continuous between the corresponding signal line S and the corresponding pixel electrode PE.

The liquid crystal display device comprises, as driving circuits, a Y driver YD which sequentially drives the plurality of G(1) to G(M) so as to make the plurality of pixel switches SW on each row electrically continuous and which drives the plurality of auxiliary capacitance lines Cs(1) to Cs(M+1), and an X driver XD that output a video signal and a counter-transfer preventing signal to each of the plurality of signal lines S(1) to S(N) during a period when the pixel switches SW on each row are made electrically continuous by driving of the corresponding gate line G.

The Y driver YD and the X driver XD may be mounted as external ICs or constructed on the array circuit AR as a built-in circuit. In the liquid crystal display device according to the present embodiment, the Y driver YD and the X driver XD are arranged around the display area ACT. Operation of the Y driver YD and the X driver XD is controlled by the control circuit CTR.

In FIG. 1, the Y driver YD is located to the left of the display area ACT, but in some cases, may be located to the right of the display area ACT. Alternatively, two Y drivers YD with the same function may be arranged symmetrically on the right side and the left side, respectively. Alternatively, the Y driver YD may be separated into a function to drive the gate line G and a function to drive the auxiliary capacitance line Cs, each of which may be arranged on the right side or the left side.

The counter substrate CT comprises, for example, color filters (not shown in the drawings) each formed of a red colored layer, a green colored layer, and a blue colored layer arranged on the transparent insulating substrate (not shown in the drawings) such as glass, and counter electrodes (not shown in the drawings) arranged on the respective color filters opposite the plurality of pixel electrodes PE.

The pixel electrodes PE and the counter electrodes are each formed of, for example, a transparent electrode material such as ITO (indium Tin Oxide) and are covered with respective orientation films (not shown in the drawings) oriented in parallel directions (the orientation films are, for example, rubbed or photo-oriented). Each pixel electrode PE and each counter electrode forms a display pixel PX together with a pixel area (not shown in the drawings) that is a part of a liquid crystal layer which is controlled by a liquid crystal molecular sequence corresponding to electric fields from the pixel electrode PE and the counter electrode.

The plurality of color display pixels are classified into groups according to the color of the colored layer in the color filter located in the color display pixel. A red display pixel PXR includes a red colored layer. A green display pixel PXG includes a green colored layer. A blue display pixel PXB includes a blue colored layer. The color filter is located on one of the array substrate AR and the counter substrate CT on a liquid crystal layer side of the transparent insulating substrate or a side of the transparent insulating substrate opposite to the liquid crystal layer.

Each of the plurality of display pixels PX comprises a liquid crystal capacitance (not shown in the drawings) formed of a liquid crystal layer held between the pixel electrode PE and the counter electrode. The liquid crystal capacitance is determined by the relative permitivity of the liquid crystal material, the area of the pixel electrode, and a liquid crystal cell gap.

A voltage applied to the signal line S by the X driver XD (the voltage is hereinafter referred to as a source voltage) is applied to the pixel electrode PE of the display electrode PX on the selected row via the corresponding pixel switch SW. The potential difference between the voltage applied to the pixel electrode PE (pixel voltage) and a counter voltage Vcom applied to the corresponding counter electrode is held in the corresponding liquid crystal capacitor.

Furthermore, for example, a part of the pixel electrode PE and the corresponding auxiliary capacitance line Cs (Cs(1) to Cs(M+1)) stacked via an insulating film form an auxiliary capacitance Cst. During a period when a signal written to the pixel electrode PE is held, the auxiliary capacitance Cst is coupled to the liquid crystal capacitance. The auxiliary capacitance Cst may be formed between the drain of the corresponding switch SW and the corresponding auxiliary capacitance line Cs stacked via an insulating film or between a semiconductor layer in the corresponding switch element SW and the corresponding auxiliary capacitance line Cs stacked via an insulating line.

The control circuit CTR outputs control signals generated based on a synchronizing signal input by an external signal source to the Y driver YD, and outputs, to the X driver XD, control signals generated based on the synchronizing signal input by the external signal source, and reverse transition preventing signals for black insertion or video signals input by the external signal source. Moreover, the control circuit CTR outputs the counter voltage Vcom applied to the counter electrode of the counter substrate CT to the counter electrode driver (not shown in the drawings). The control circuit CTR may output the counter voltage Vcom to the counter electrode directly.

The control signals output to the Y driver YD by the control circuit CTR include a scan direction control signal UD for switching between an up-down scan (first scan) and a down-up scan (second scan), a Cs polarity control signal FR for controlling the polarity of a superimposed voltage resulting from capacitive coupling, a start pulse signal STV for controlling operation of shift registers, and clock signals CLK1 and CLK2.

The X driver SD outputs a plurality of video signals or reverse transition preventing signals to the signal lines S in parallel.

The liquid crystal display device according to the present embodiment adopts CCDI driving. The CCDI driving involves writing from the signal line to any pixel and then providing the superimposed voltage resulting from capacitive coupling to the pixel potential via the auxiliary capacitance line Cst to exert an amplitude increase effect. The CCDI driving provides a pixel holding voltage amplitude larger than the range of signals voltages (video signal amplitude) applied to the signal lien S by the X driver XD. This enables the use of an X driver XD with a reduced voltage amplitude, advantageously enabling a reduction in driver costs and in power consumption.

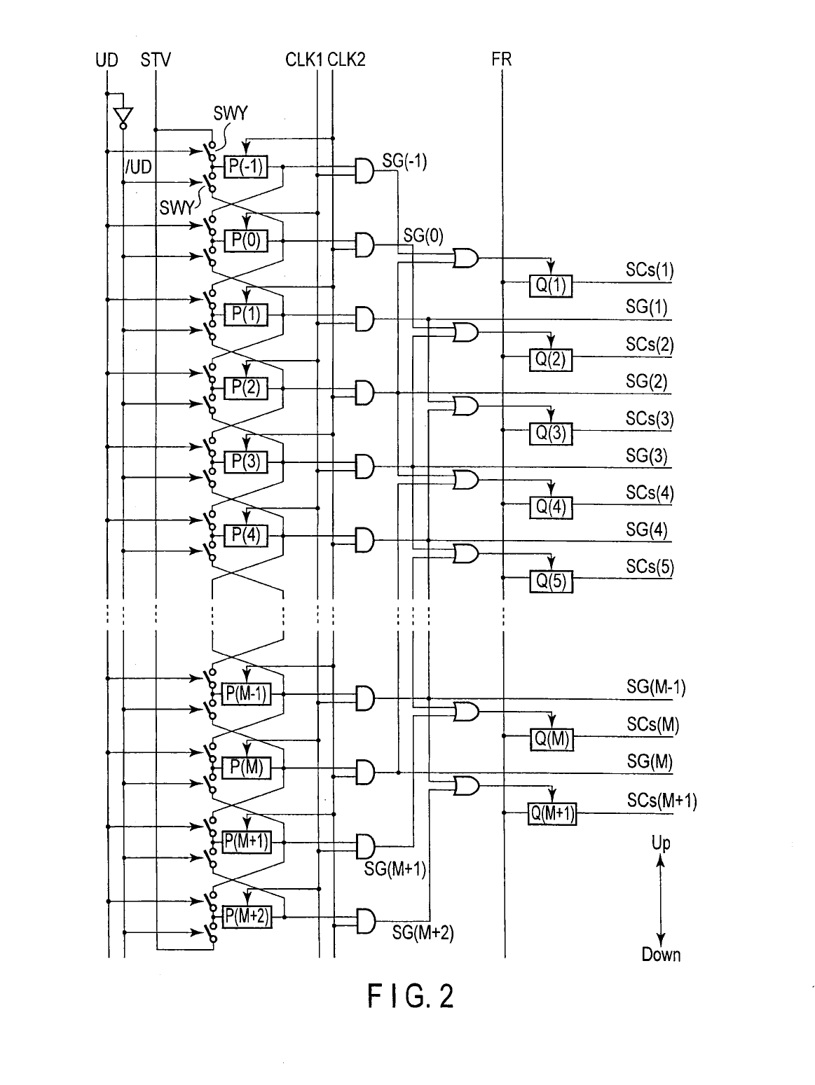

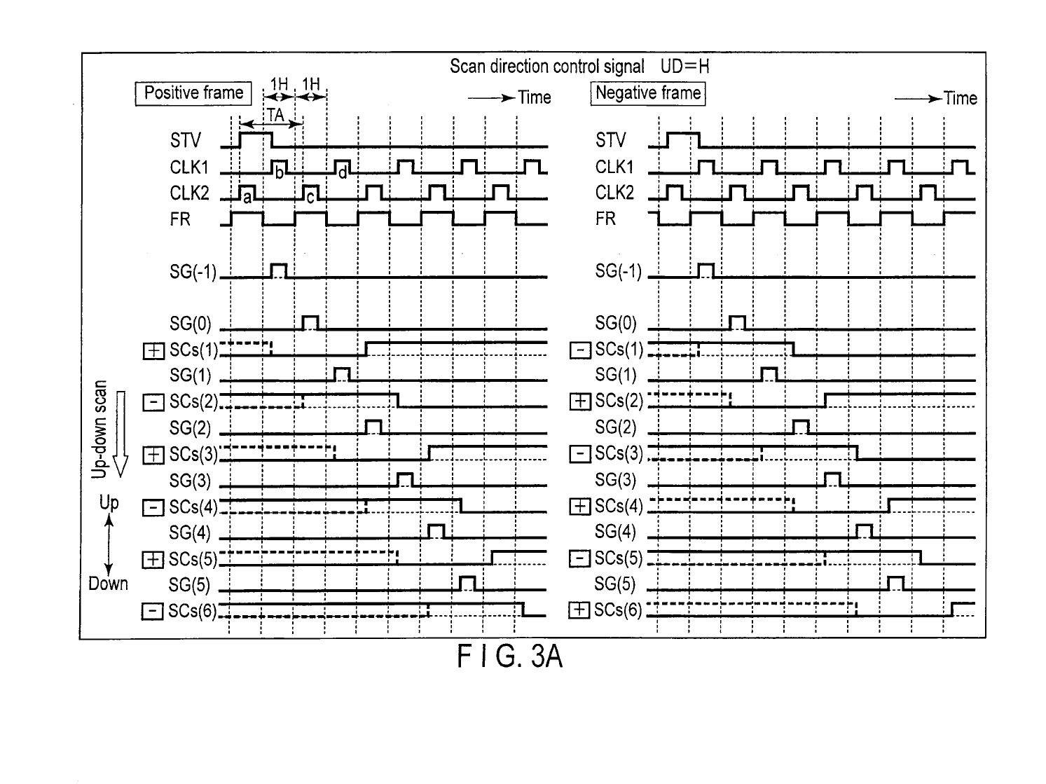

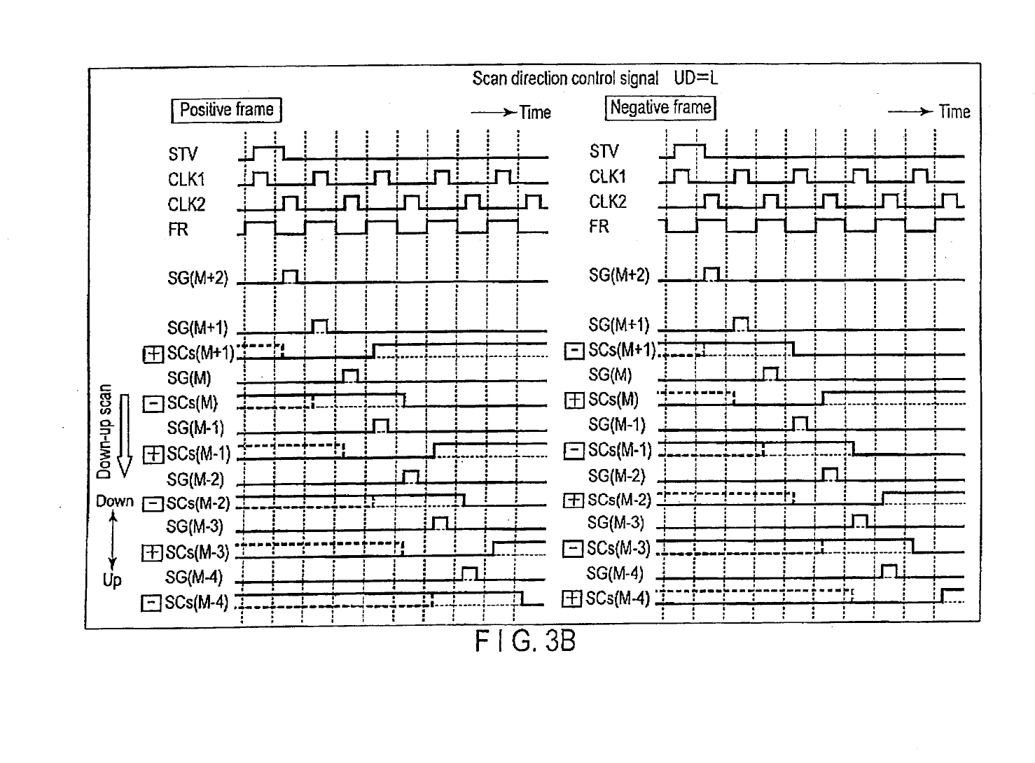

Operation of gate line G and the auxiliary capacitance line Cs during CCDI driving will be described with reference to a circuit block diagram of the Y driver YD shown in FIG. 2 and a timing chart of driving waveforms shown in FIG. 3.

FIG. 2 is a diagram showing an example of the Y driver YD in the liquid crystal display device shown in FIG. 1. Input signals are denoted by UD, STV, CLK1, CLK2, and FR and each have a logical value for either a high voltage state (hereinafter referred to as H) or a low voltage state (hereinafter referred to as L).

Here, UD denotes the scan direction control signal for switching between the up-down scan and the down-up scan. /UD denotes a signal obtained by inverting the scan direction control signal UD. STV denotes a start pulse signal for controlling the operation of the shift registers described below. CLK1 and CLK2 denote clock signals. FR denotes the Cs polarity control signal for controlling the polarity of the superimposed voltage resulting from capacitive coupling.

Output signals from the Y driver YD are gate signals (SG(1) to SG(M)) output to the corresponding gate lines (G(1) to G(M)) in the display area and Cs signals (SCs(1) to SCs(M+1)) output to the corresponding auxiliary capacitance lines (Cs(1) to Cs(M+1)) in the display area.

Here, M denotes the number of gate lines G arranged in the display area ACT, which is even in FIG. 2. In the display area ACT, the auxiliary capacitance line Cs is arranged above and below the corresponding gate line G. Thus, the number of auxiliary capacitance lines is larger than the number of gate lines G by one; the total number of auxiliary capacitance lines Cs is (M+1). In addition, on the circuit diagram shown in FIG. 2, the gate signals SG(1) to SG(M) and the Cs signals SCs(1) to SCs(M+1) are treated as logic signals. However, in actuality, these signals may be subjected to voltage conversion through a level shifter and then output to the display area ACT. The voltage conversion is not an essential component for the description of the present embodiment and will thus not be described.

In FIG. 2, switch elements are denoted by switch symbols (for example, dented by SWY). Each of the switch elements is turned on when the corresponding control terminal (scan direction control signal UD or inverted scan direction control signal /UD) is at an H level and turned off when the control terminal is at an L level.

Two switch elements SWY are located on an input side of one register P(k): one of the switch elements SWY switches a connection to the output end of a register P(k−1) located above the register P(k), and the other switch element SWY switches a connection to the output end of a register P(k+1) located below the register P(k). On the input side of an uppermost register P(−1), one of the switch elements SWY switches a connection to an input end for the start pulse signal STV, and the other switch element SWY switches a connection to the output end of a register P(0) located below the register P(−1). On the input side of a lowermost register P(M+2), one of the switch elements SWY switches a connection to the output end of a register P(M+1) located above the register P(M+2), and the other switch element SWY switches a connection to an input end for the start pulse signal STV.

P(k) (k=−1, 0, 1, 2, . . . , M+2) denotes the register. The register has a function to retrieve and store a value on an input side (the left side of the register in FIG. 2) upon receiving the H level from a control terminal shown by an arrow (clock signal CLK1 or clock signal CLK2) and to hold the retrieved value even though the control terminal signal subsequently changes to the L level, until the control terminal signal changes to the H level again. The held value is constantly output to an output side of the register P(k) (the right side of the register in FIG. 2).

As described above, for example, when the scan direction control signal UD is at the H level (that is, the inverted scan direction control signal /UD is at the L level), the start pulse signal STV is stored in the registers in the following order in a chained manner, in synchronism with the clock signal CLK1 or the clock signal CLK2: P(−1), P(0), P(1), . . . , P(M+1), P(M+2). The registers thus function as shift registers to allow scanning to be carried out in an up-down direction (first direction).

Furthermore, when the scan direction control signal UD is at the L level (that is, the inverted scan direction control signal /UD is at the H level), the start pulse signal STV is stored in the registers in the following order in a chained manner, in synchronism with the clock signal CLK1 or the clock signal CLK2: P(M+2), P(M+1), P(M), . . . , P(0), P(−1). The registers thus function as shift registers to allow scanning to be carried out in a down-up direction (second direction).

An output from the register P(k) is transmitted to the gate lines G(1) to G(M) in the display area ACT as a gate signal SG(k) after the output and the clock signal CLK1 or the clock signal CLK2 are ANDed together. However, gate signals SG(−1), SG(0), SG(M+1), and SG(M+2) are not output to the display area ACT.

Here, the output signal from the register P(k) and the clock signal CLK1 or the clock signal CLK2 are ANDed together in order to shape pulses using the clock signal CLK1 or the clock signal CLK2 (that is, to adjust a rise timing and a fall timing for the gate signal during a horizontal period (H)).

Registers Q(j) (j=1, 2, . . . , M+1) are configured to generate Cs signals and function similarly to the registers P(k). That is, the register Q(j) retrieves the scan direction control signal FR at a timing when G(j−2) or G(j+1) changes to the H level and outputs a Cs signal SCs(j) to an auxiliary capacitance line Cs(j) in the display area (j=1, 2, . . . , M+1). At the other timings, the state of the register Q(j) is not changed but held.

FIG. 3A and FIG. 3B are timing charts illustrating an example of a method for driving the liquid crystal display device according to the present embodiment.

Based on the above description, operation of the gate signal SG and the Cs signal SCs performed when the scan direction control signal UD is at the H level will be described with reference to FIG. 3A and FIG. 3B. Here, the liquid crystal display device generally carries out AC driving, and allows each pixel PX to operate with the display polarity thereof inverted on a frame-to-frame basis (or at intervals of two frames or three frames). Thus, two types of polarity patterns are present. The polarity patterns are hereinafter distinguished from each other by referring to one of the polarity patterns as a positive frame, while referring to the other polarity pattern as a negative frame.

First, it is assumed that in the positive frame, the start pulse signal STV, clock signal CLK1, clock signal CLK2, and Cs polarity control signal FR as shown in FIG. 2 are input. The Cs polarity control signal FR repeatedly rises and falls at given timings so that the period of the H level is the same as the period of the L level (one horizontal period (1H)). The clock signal CLK1 is at the H level during a predetermined period while the Cs polarity control signal FR is at the H level. The clock signal CLK2 is at the L level during a predetermined period while the Cs polarity control signal FR is at the L level. The start pulse signal STV rises at a timing when the clock signal CLK2 rises, and falls at a timing when the clock signal CLK1 subsequently rises.

Now, the operation will be described in connection with the register P(−1). The H level is loaded into the register P(−1) when the clock signal CLK2 changes to the H level (this corresponds to a pulse (a) shown in FIG. 3A) while the start pulse signal STV is at the H level. Thereafter, the register P(−1) holds the H level even when the clock signal CLK2 subsequently changes to the L level and until the clock signal CLK2 changes to the H level (this corresponds to a pulse (c) shown in FIG. 3A) to allow a start pulse of the L level to be retrieved. Thus, the H level signal is stored in the register P(−1) during a period TA between the rise of the pulse (a) and the rise of the pulse (c). While the register P(−1) is at the H level, clock signal CLK1 is at the H level (this corresponds to a pulse (b)). As the logical AND of both register P(−1) and clock signal CLK1, the shape of the pulse (b) is directly output as the gate signal SG(−1).

Now, the operation will be described in connection with the register P(0). The input side of the register P(0) is connected to the output end of the register P(−1). Thus, the input of the register P(0) corresponds to the output of the register P(−1) (that is, the state of P(−1)). Consequently, when the clock signal CLK1 changes to the H level (this corresponds o the pulse (b) in FIG. 3A) while the output from the register P(−1) is at the H level, the register P(0) retrieves the H level to change to the H level.

This state is held until the clock signal CLK1 subsequently changes to the H level (this corresponds to a pulse (d) in FIG. 3A) to allow the L level to be retrieved. When the clock signal CLK2 changes to the H level (this corresponds to the pulse (c) in FIG. 3A) while the register P(0) is at the H level, as the logical AND of both H level signals, the shape of the pulse (c) is directly output as the gate signal SG(0). This also applies to SG(1), SG(2), . . . , and it should be appreciated that the H level pulse of the gate signal SG is shifted at every horizontal period (1H).

The Cs signal SCs can be described with reference to the gate signal SG(k). That is, when the gate signal SG(k) changes to the H level, a register Q(k−1) and a register Q(k+2) retrieve the polarity control signal FR and then output the polarity control signal to a Cs signal SCs(k−1) and a Cs signal SCs(k+2).

For example, during the horizontal period (1H) when the gate signal SG(2) is at the H level, the Cs polarity control signal FR is at the H level. Thus, at the same timing as that when the gate signal SG(2) changes to the H level, the Cs signal SCs(1) and the Cs signal SCs(4) change to the H level.

Regardless of whether the Cs signal SCs(4) is at the H level (solid line) or the L level (dashed line) before the gate signal SG(2) changes to the H level, the Cs signal SCs(4) is fixed to the H level once the gate signal SG(2) changes to the H level. This also applies to the gate signals other than the gate signal SG(2). Hence, each Cs signal SCs operates as shown in FIG. 3A.

In connection with the shape of each Cs signal SCs, the Cs polarity control signal FR is retrieved once before the gate signals shown above and below the Cs signal SCs sequentially change to the H level and once after the gate signals shown above and below the Cs signal SCs sequentially change to the H level. During the first retrieval of the Cs polarity control signal FR, as described above, the Cs signal SCs is fixed to one of the H level and the L level regardless of the preceding state of the Cs signal SCs (that is, the preceding state is reset, and the Cs signal SCs changes to a state specified by the Cs polarity control signal FR).

During the second retrieval of the Cs polarity control signal FR, the Cs signal SCs changes to a state opposite to the state thereof during the first retrieval. That is, the time difference between the first retrieval of the Cs polarity control signal FR and the second retrieval of the Cs polarity control signal FR is an odd number of times as long as the horizontal period (H). Thus, the state inevitably changes to the opposite one. This transition operation during the second retrieval of the Cs polarity control signal FR allows application of a superimposed voltage to the pixel potential, which is the essence of the CCDI driving.

Now, the change of the Cs signal SCs from the L level to the H level is referred to as a “positive polarity”. The change of the Cs signal SCs from the H level to the L level is referred to as a “negative polarity”. The corresponding Cs signals SCs carry the symbol “+” indicative of the “positive polarity” and the symbol “−” indicative of the “negative polarity”, respectively.

For a negative frame, the driving is performed with the level of the Cs polarity control signal FR in the input signal inverted with respect to a positive frame. The other signals, the start pulse signal STV, the clock signal CLK1, and the clock signal CLK2, have exactly the same waveform as that in the positive frame.

In this case, the gate signal is exactly the same as that in the positive frame. The Cs signal SCs has its level inverted with respect to the positive frame inverted. This causes each Cs signal SCs to be inverted between the “positive polarity” and the “negative polarity”.

Now, the effect of the first retrieval of the Cs polarity control signal FR will be additionally described. As described above, not only the positive frame and the negative frame may be alternately operated (that is, the frames may be alternately inverted on a frame-to-frame basis) but also the frames may be inverted at intervals of at least two frames.

For example, when black insertion driving is carried out on a liquid crystal display device in an OCB (Optically Compensated Bend) mode, the display polarity of the pixel PX may be inverted in the following order: reverse transition preventing signal (positive polarity), video signal (positive polarity), reverse transition preventing signal (negative polarity), video signal (negative polarity), reverse transition preventing signal (positive polarity), . . . . That is, the polarity may be inverted at intervals of substantially two frames.

Furthermore, when time-sharing 3D (three-dimensional) display is provided, the display polarity of the pixel PX may be inverted in the following order: left video signal (positive polarity), right video signal (positive polarity), left video signal (negative polarity), right video signal (negative polarity), left video signal (positive polarity), . . . in order to prevent the display polarity from being biased. Thus, the polarity inversion at intervals of two frames may also be adopted.

Alternatively, when a liquid crystal display device in the OCB mode further provides time-sharing 3D display, the display polarity of the pixel PX may be inverted in the following order: reverse transition preventing signal (positive polarity), left video signal (positive polarity), reverse transition preventing signal (positive polarity), right video signal (positive polarity), reverse transition preventing signal (negative polarity), left video signal (negative polarity), reverse transition preventing signal (negative polarity), right video signal (negative polarity), reverse transition preventing signal (positive polarity), . . . . That is, the polarity may be inverted at intervals of substantially four frames.

In these cases, a certain frame may have the same polarity as that of a frame preceding the certain frame or a polarity different from the polarity of the certain frame. This means that for example, the state of the Cs signals SCs shown in FIG. 3A before the first retrieval of the Cs polarity control signal FR may be as shown by a dashed line or as shown by a solid line. When this mixture is reset to change the Cs signal SCs to one of the states during the first retrieval of the Cs polarity control signal FR, the transition of the Cs signal SCs resulting from the second retrieval of the Cs polarity control signal FR may be constantly achieved correctly.

Now, operation of the gate signal SG and the Cs signal SCs performed when a down-up scan is carried out (when the scan direction control signal UD is at the L level) will be described with reference to FIG. 3B. In this case, the gate lines G are scanned in the down-up direction. That is, the switch element SWY located on the input side of the register P(k) shown in FIG. 2 and connected to the register located below the register P(k) is made electrically continuous to store the start pulse signal STV in the registers in the following order in a chained manner, in synchronism with the clock signal CLK1 or the clock signal CLK2: the register P(M+1), the register P(M), . . . , the register P(0), the register P(−1). The registers function as shift registers to allow scanning to be carried out in the down-up direction.

In conjunction with the operation of the register P(k), the Cs polarity control signal FR is stored in the registers Q(j) in the following order in a chained manner: the register Q(M+1), the register Q(M), . . . , the register Q(2), and the register Q(1).

That is, a comparison between the cause of the up-down scan shown in FIG. 3A and the case of the down-up scan shown in FIG. 3B indicates that the scan direction control signal UD, the clock signal CLK1, and the clock signal CLK2 are each inverted between these cases. Furthermore, the shift register P(k) in the up-down scan corresponds to the shift register (M+1−k) (k=−1, 0, 1, . . . , M+2) in the down-up direction. The shift register Q(j) in the up-down scan corresponds to the shift register Q(j+2−k) (j=1, 2, . . . , M+1) in the down-up direction.

As a result, the vertical scan direction is inverted. The gate line G(k) in the up-down scan corresponds to the gate line G(M+1−k) (k=−1, 0, 1, . . . , M+2) in the down-up direction. The auxiliary capacitance line Cs(j) in the up-down scan corresponds to the auxiliary capacitance line Cs(M+2−j) (j=1, 2, . . . , M+1) in the down-up direction.

The timings for the clock signal CLK1 and the clock signal CLK2 in FIG. 3B are opposite to the timings for the clock signal CLK1 and the clock signal CLK2 in FIG. 3A. This is because the connection pattern for the clock signal CLK1 and the connection pattern for the clock signal CLK2 alternate on a row-to-row basis and because in the description of the present embodiment, M is an even number. When M is an odd number, the clock signal CLK1 and the clock signal CLK2 have the same waveforms regardless of whether scanning is carried out in the up-down direction or in the down-up direction.

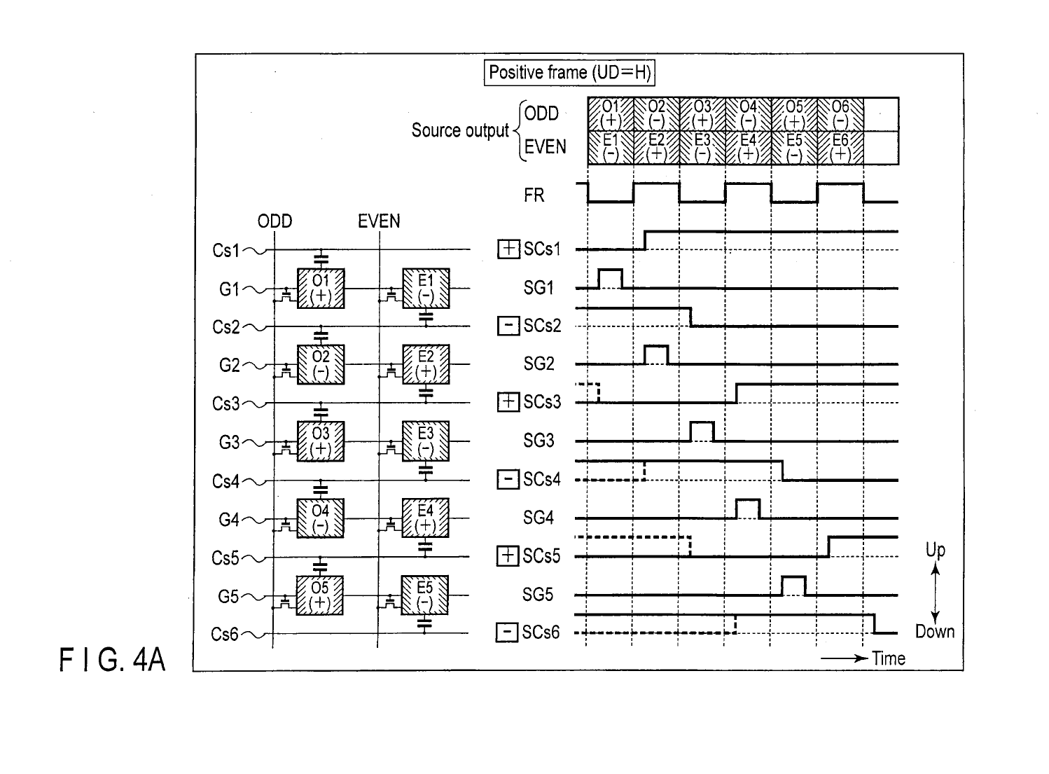

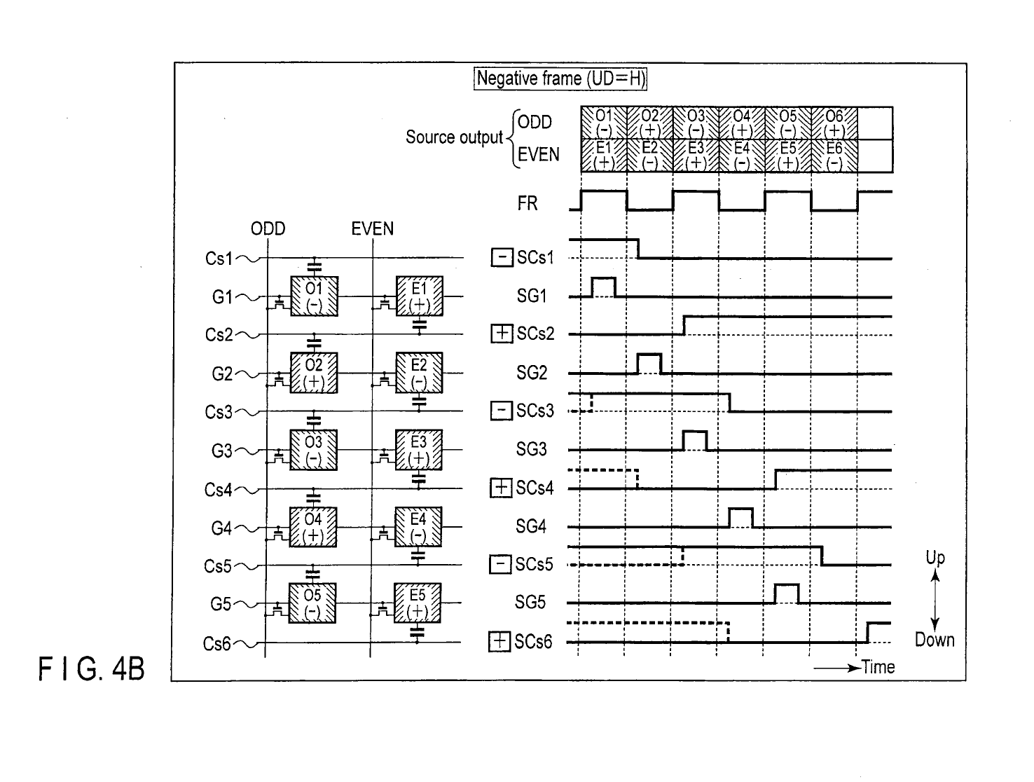

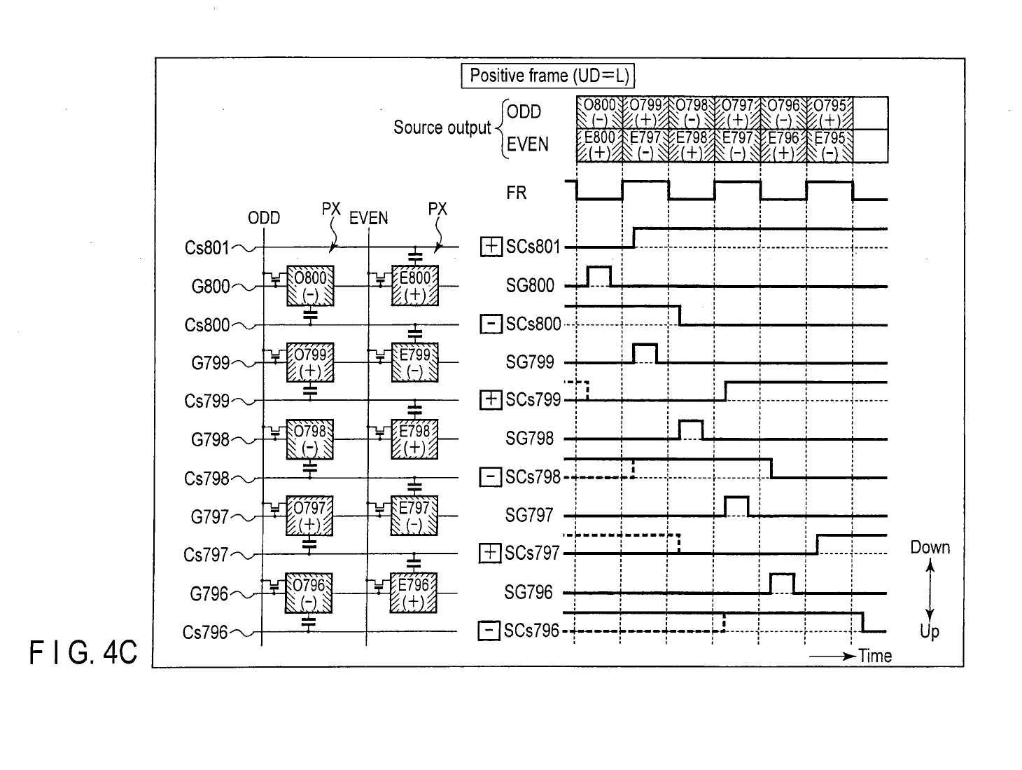

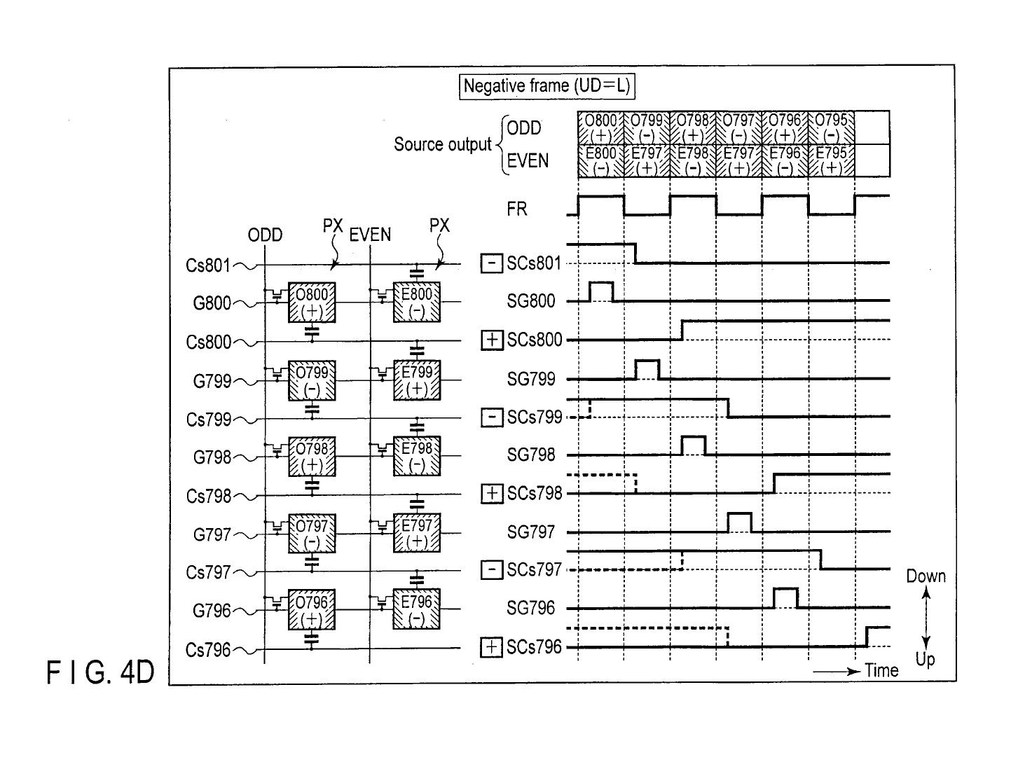

FIG. 4A and FIG. 4B are timing charts illustrating an example of a driving method of carrying out an up-down scan in a liquid crystal display device adapted for 1H1V-CCDI.

Based on the waveforms of the gate signal SG and the Cs signal SCs, the relation between the polarity of a superimposed voltage resulting from CCDI driving and the polarity of a signal output to the signal line S (this signal corresponds to a source output) will be described.

First, 1H1V-CCDI driving, the most basic CCDI driving, will be described with reference to FIG. 4A and FIG. 4B. The 1H1V is a scheme in which an array of the display polarities of the pixels PX is inverted on a column-to-column and row-to-row basis, that is, the pixels PX with the positive display polarity and the pixels PX with the negative display polarity are arranged in a checkered manner.

The 1H1V inversion is advantageous in that the positive polarity and the negative polarity are mixed together during a write to each row, thus for example allowing coupling of the signal line S to the counter electrode to be offset by the positive and negative polarities to enable possible horizontal crosstalk to be prevented. Additionally, line inversion driving and column inversion driving make a line flicker visible, for example, when the counter electrode potential deviates. However, dot inversion advantageously makes a line flicker difficult to see even when the counter electrode potential deviates.

In the 1H1V inversion driving, as shown in a pixel layout for a positive frame shown in FIG. 4A, the auxiliary capacitance Cst for each pixel PX is connected to the auxiliary capacitance line Cs located above or below the pixel electrode PE in FIG. 4A. However, the auxiliary capacitance Cst is alternately connected to the auxiliary capacitance line Cs located above the pixel electrode PE and to the auxiliary capacitance line Cs located below the pixel electrode PE, on a column-to-column basis. That is, for example, the auxiliary capacitance Cst for the pixel PX belonging to an odd-number-th column (the column ODD in FIG. 4A) is connected to the auxiliary capacitance line Cs located above the pixel electrode PE. The auxiliary capacitance Cst for the pixel PX belonging to an even-number-th column (the column EVEN in FIG. 4A) is connected to the auxiliary capacitance line Cs located below the pixel electrode PE.

Here, FIG. 4A and FIG. 4B show, to the right of the pixel layout, the waveforms of the gate signal SG, the Cs signal SCs, and the Cs polarity control signal FR and the polarity of each Cs signal SCs during an up-down scan (in which the scan direction control signal UD is at the H level) in association with the gate lines G and the auxiliary capacitance lines Cs, for a positive frame and a negative frame, respectively. The signal waveforms shown in FIG. 4A are similar to the waveforms of the gate signal SG, the Cs signal SCs, and the Cs polarity control signal FR and the polarity of each Cs signal SCs during an up-down scan for the positive frame shown in FIG. 3A.

The operation will further be described in connection with, for example, a gate line G1. During a horizontal period (1H) following a change of a gate signal SG1 to the H level, a Cs signal SCs1 from an auxiliary capacitance line Cs1 located above the gate line G1 changes from the L level to the H level (the Cs signal SCs1 has the “positive polarity”). Moreover, during the next horizontal period (1H), a Cs signal SCs2 from a auxiliary capacitance line Cs2 located below the gate line G1 changes from the H level to the L level (the Cs signal SCs2 has the “negative polarity”).

This means as follows. For a pixel PE(O1) with the auxiliary capacitance Cst connected to the auxiliary capacitance line Cs1 located above the pixel electrode PE, a positive superimposed voltage resulting from capacitive coupling is applied to the pixel potential via the auxiliary capacitance Cst after the relevant signal is written to the pixel electrode PE. For a pixel PX (E1) with the auxiliary capacitance Cst connected to auxiliary capacitance line Cs1 located below the pixel electrode PE, a negative superimposed voltage resulting from capacitive coupling is applied to the pixel potential via the auxiliary capacitance Cst after the relevant signal is written to the pixel electrode PE.

Applying a superimposed voltage of the correct polarity to the pixel potential requires that the polarity of the superimposed voltage match the polarity of a source output from the X driver XD such as the video signal or the reverse transition preventing signal (for example, the signal corresponding to black display). When this condition is not satisfied, then for example, the black and white in the display may disadvantageously be inverted. Thus, during a horizontal period when the gate signal SG1 is at the H level, the source output to the signal line S on the odd-number-th (ODD) column needs to have the positive polarity. Furthermore, the source output to the signal line S on the even-number-th (EVEN) column needs to have the negative polarity.

Sequential application of a similar concept to the rows of a gate line G2, a gate line G3, . . . allows determination of the polarity of the superimposed voltage to be provided to the pixel electrodes PE on each row and the polarity of the source output to be provided in association with the polarity of the superimposed voltage. The thus determined polarity of the superimposed voltage is shown on each pixel PX. Furthermore, the thus determined polarity of the source output is shown above the waveform of the Cs polarity control signal FR. FIG. 4A definitely shows that the polarities of the pixels PX are distributed in a 1H1V inversion pattern in a checkered manner.

FIG. 4B shows, for a negative frame, the same pixel layout as that for the positive frame, and the waveforms of the Cs signal and the FR signal, and the polarity of each Cs signal which are similar to those for the negative frame in FIG. 3A.

Here, the polarity of the Cs signal SCs is opposite to that in the positive frame. Thus, the polarity of the superimposed voltage to be provided to each pixel electrodes PE and the polarity of the source output to be provided in association with the polarity of the superimposed voltage are also opposite to those in the positive frame. As a result, a pixel polarity pattern and a source output polarity pattern as shown in FIG. 4B are obtained.

FIG. 4C and FIG. 4D are timing charts illustrating an example of a driving method of carrying out a down-up scan in the liquid crystal display device adapted for 1H1V-CCDI driving.

Now, with reference to FIG. 4C and FIG. 4D, a case of a down-up scan (where the scan direction control signal UD is at the L level) will be described. The present embodiment describes a case where M is 800. FIG. 4C and FIG. 4D show pixel layouts in which the gate lines are arranged in the following order from top to bottom: G800, G799, G798, . . . and which are drawn upside down compared to FIG. 4A and FIG. 4B. Thus, the polarity of the auxiliary capacitance line Cs to which the auxiliary capacitance Cst for the pixel PX is connected is also inverted in the vertical direction. That is, the upper side in FIG. 4C and FIG. 4D corresponds to the lower side in FIG. 4A and FIG. 4B. The lower side in FIG. 4C and FIG. 4D corresponds to the upper side in FIG. 4A and FIG. 4B.

In FIG. 4A and FIG. 4B, on the odd-number-th (ODD) columns of the pixels PX, the auxiliary capacitance Cst is connected to the auxiliary capacitance line Cs located above the pixel electrode PE. On the even-number-th (EVEN) columns of the pixels PX, the auxiliary capacitance Cst is connected to the auxiliary capacitance line Cs located below the pixel electrode PE. However, in FIG. 4C and FIG. 4D, on the odd-number-th (ODD) columns, the auxiliary capacitance Cst is connected to the auxiliary capacitance line Cs located below the pixel electrode PE. On the even-number-th (EVEN) columns of the pixels PX, the auxiliary capacitance Cst is connected to the auxiliary capacitance line Cs located above the pixel electrode PE.

A comparison with FIG. 4A and FIG. 4B indicates that with respect to whether the auxiliary capacitance Cst is connected to the upper auxiliary capacitance line Cs or the lower auxiliary capacitance line Cs, the even-number-th column and the odd-number-th column in FIG. 4A and FIG. 4B are changed to the odd-number-th column and the even-number-th column, respectively, in FIG. 4C and FIG. 4D. Hence, also for the polarity of the superimposed voltage to be provided to each pixel electrodes PE and the polarity of the source output to be provided in association with the polarity of the superimposed voltage, which are determined based on the same concept as that for FIG. 4A and FIG. 4B, the even-number-th column and the odd-number-th column in FIG. 4A and FIG. 4B are changed to the odd-number-th column and the even-number-th column, respectively, in FIG. 4C and FIG. 4D. As a result, the polarity of the source output is opposite to that in the up-down scan shown in FIG. 4A.

In this case, for the waveforms of the gate signal SG and the Cs signal SCs, the gate signals SG1, SG2, . . . in FIG. 4A and FIG. 4B are changed to the gate signals SG800, SG799, . . . . The Cs signal SCs1, SCs2, . . . are changed to Cs signals SCs801, SCs800 . . . .

The case in which M is 800 has been described as an example. However, obviously, the above description also applies to cases other than the one in which M is 800.

With the results shown in FIG. 4A to FIG. 4D comprehensively considered, requirements for normal display based on the 1H1V-CCDI driving are determined to be that the polarity of the source output in a frame with one polarity of the Cs polarity control signal FR (the control signal which determines the polarity of the capacitively coupled superimposed voltage) during an up-down scan is opposite to the polarity of the source output in a frame with the same polarity of the Cs polarity control signal FR during a down-up scan. That is, the polarity of the source output for the positive frame during an up-down scan is opposite to the polarity of the source output for the positive frame during a down-up scan. Similarly, the polarity of the source output for a negative frame during an up-down scan is opposite to the polarity of the source output for the negative frame during a down-up scan.

As described above, the control circuit CTR provides output so that the phase of the polarity of the source output in a frame with one polarity of the Cs polarity control signal FR during an up-down scan is opposite to the phase of the polarity of the source output in a frame with the same polarity of the Cs polarity control signal FR during an up-down scan (in other words, the phase varies in units of horizontal periods).

As described above, the present embodiment can provide a liquid crystal display device which achieves vertically inverted display as well as high display quality, and a method for driving the liquid crystal display device.

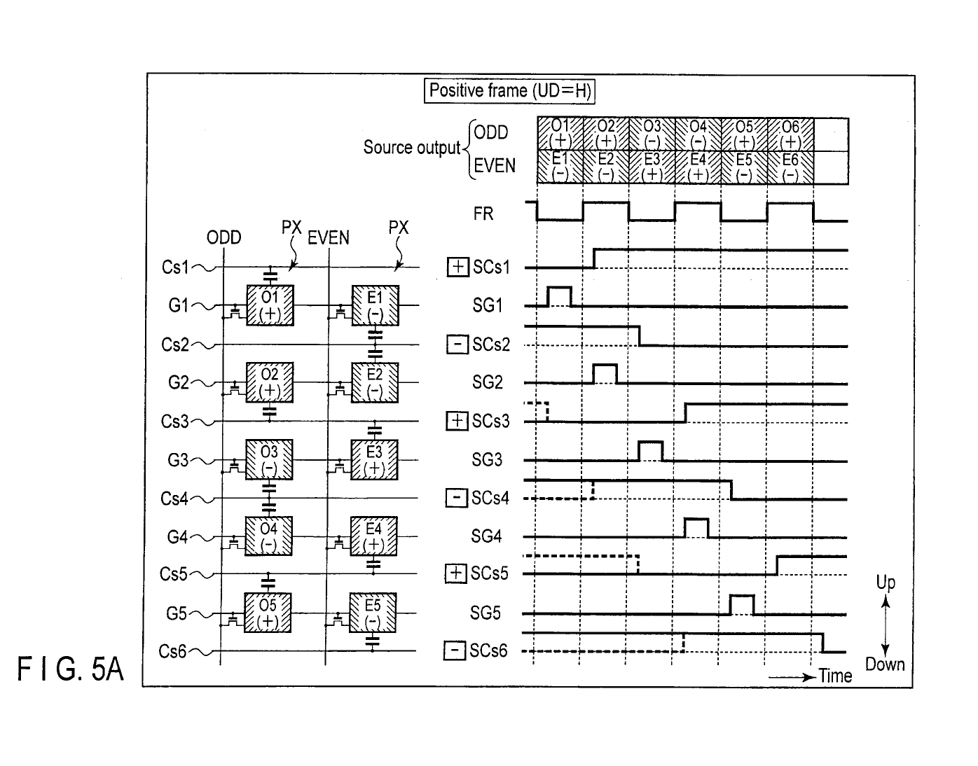

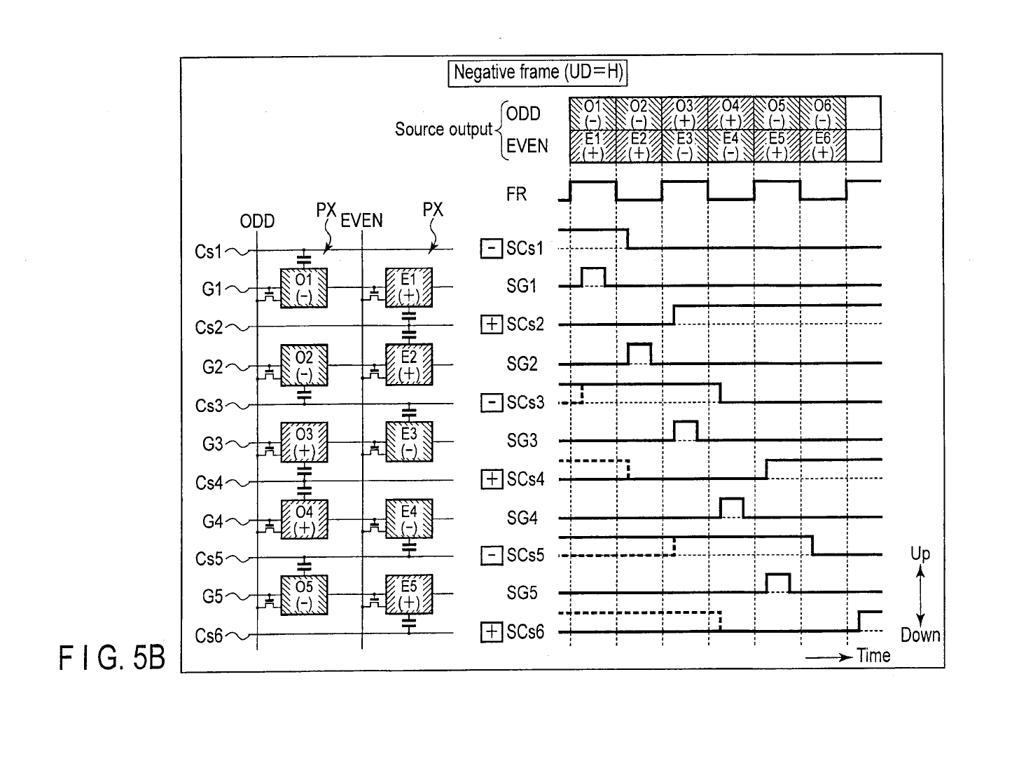

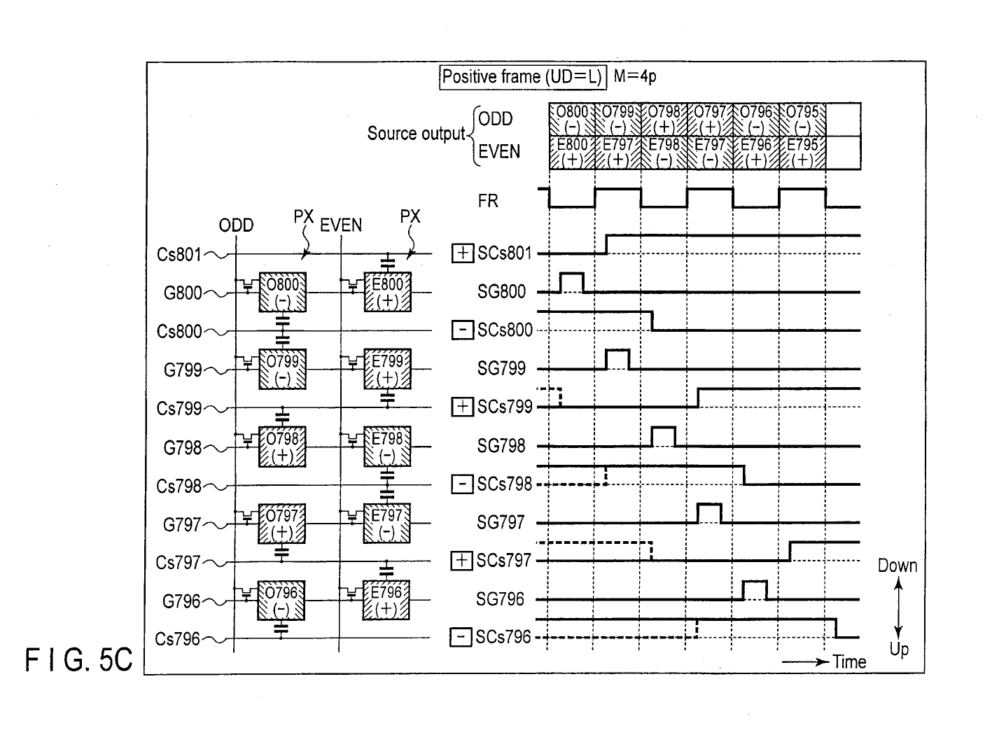

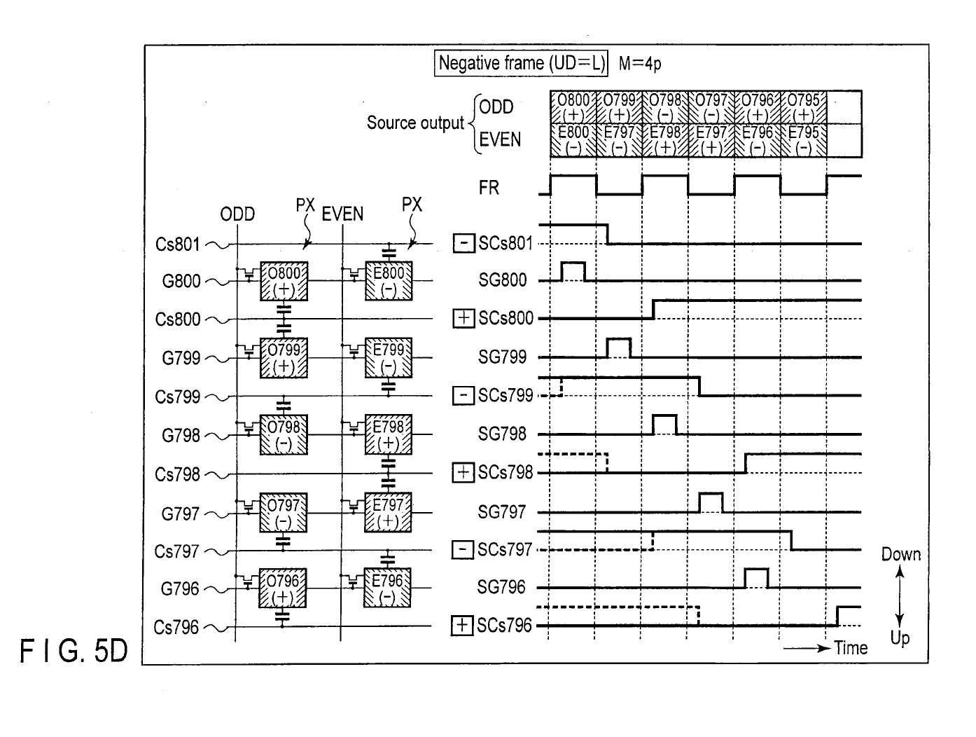

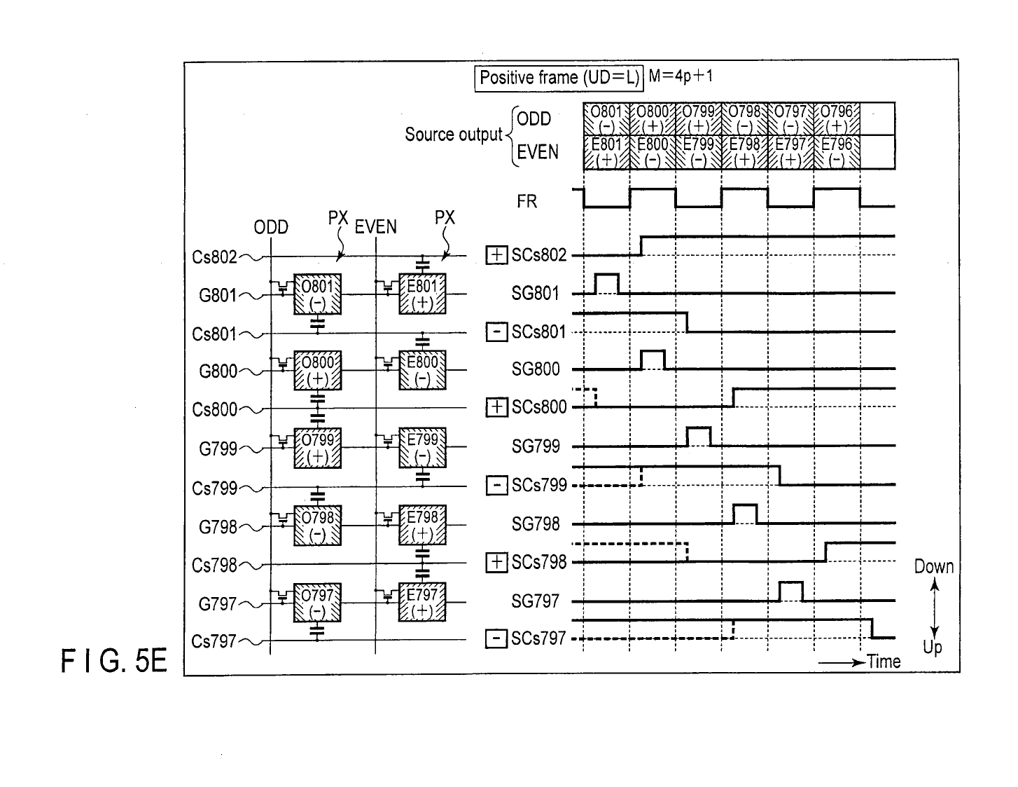

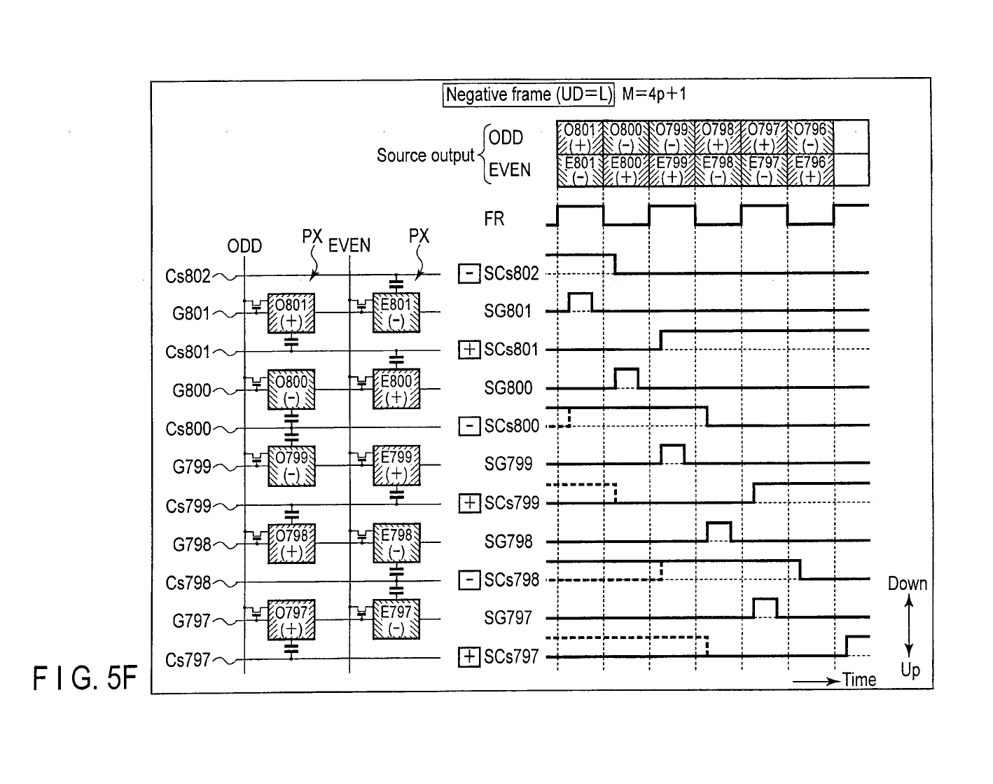

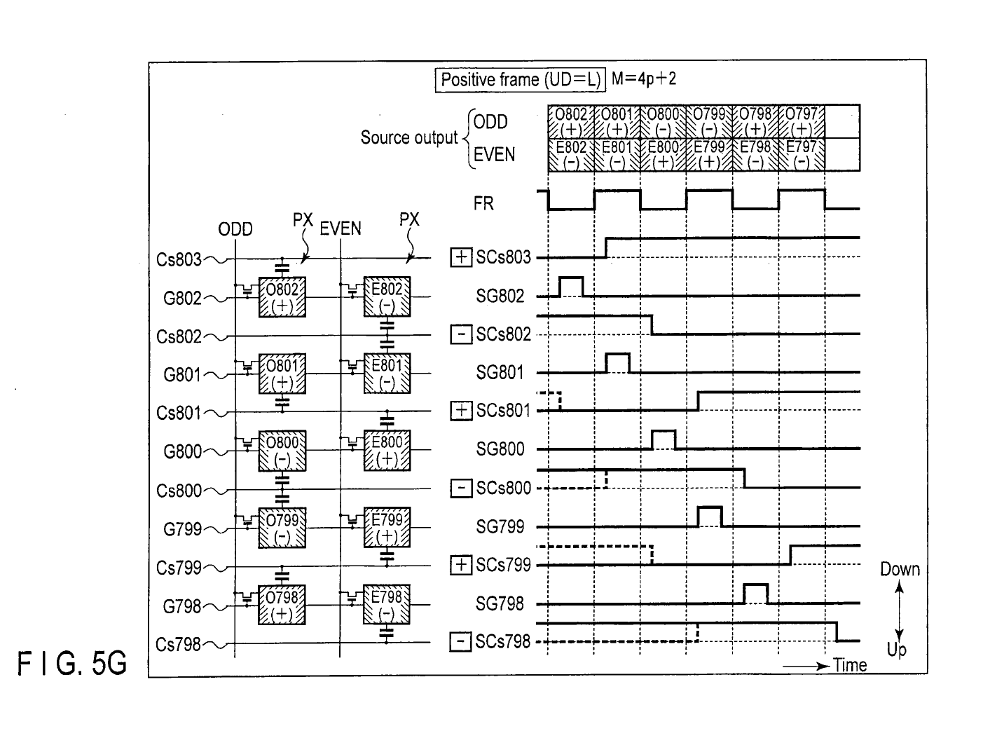

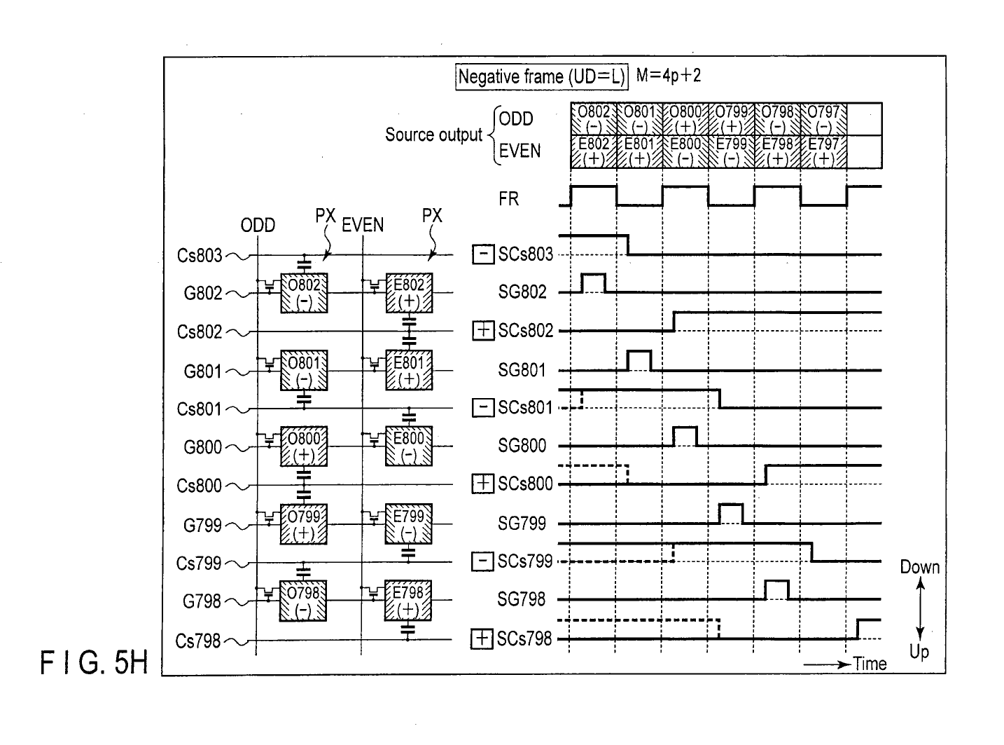

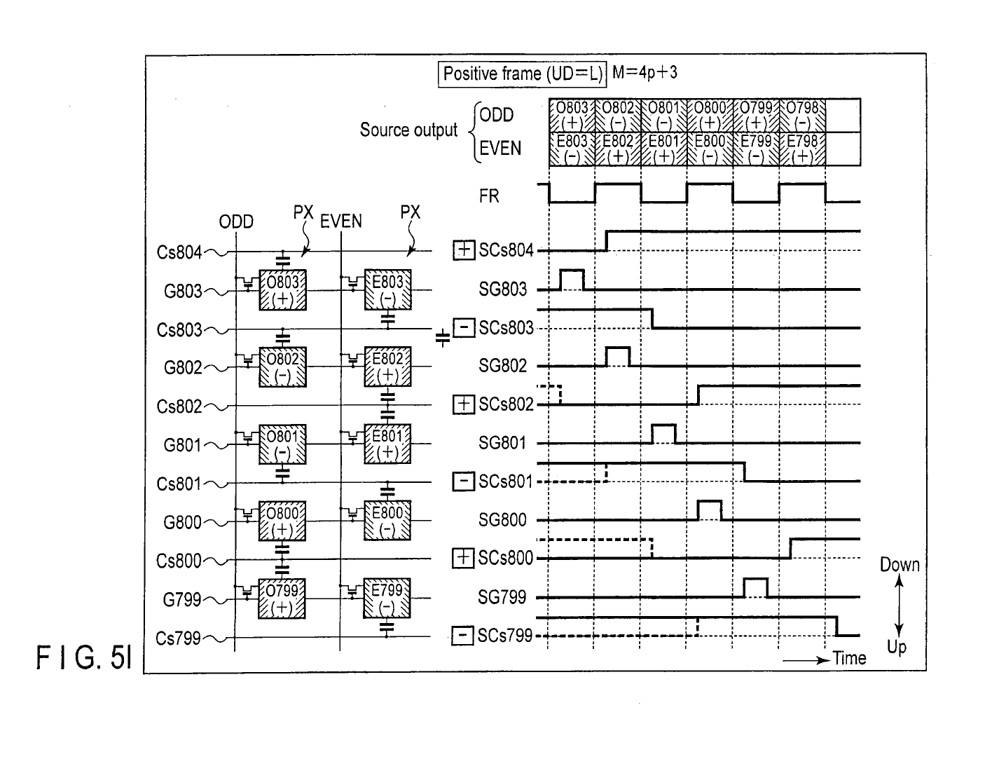

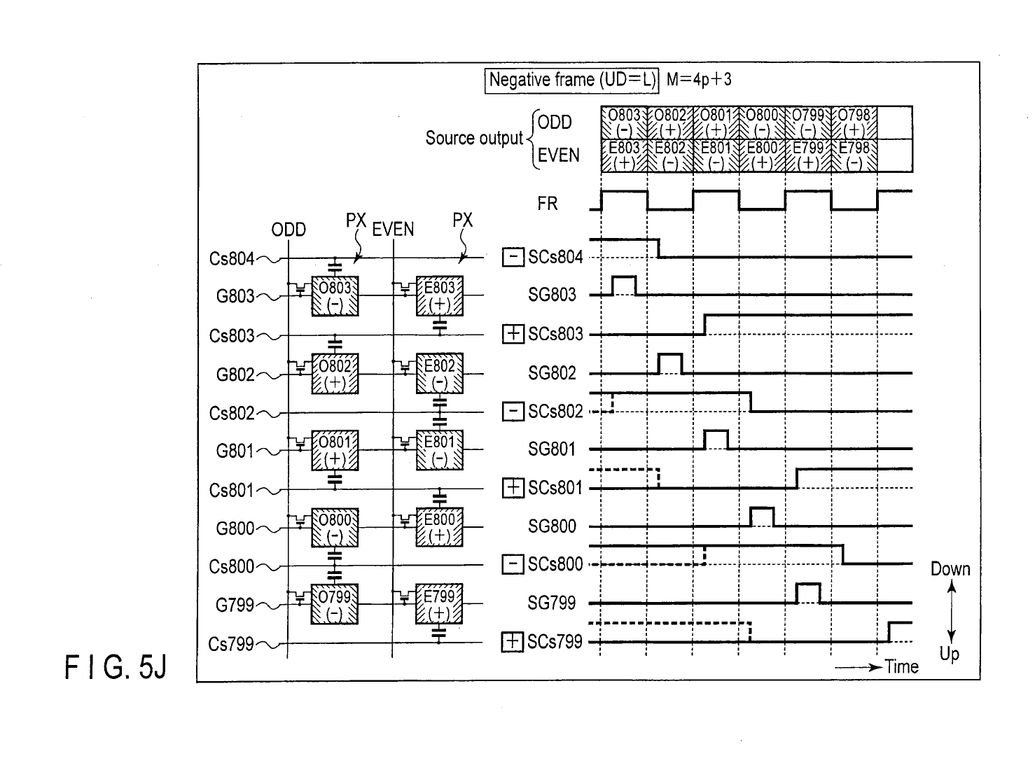

Now, a liquid crystal display device and a method for driving the liquid crystal display device according to a second embodiment will be described with reference to FIG. 5A to FIG. 5J. The liquid crystal display device according to the present embodiment adopts a driving method obtained by improving the 1H1V-CCDI driving. The present embodiment is similar to the 1H1V-CCDI driving in that the polarity of the array of the image polarities is inverted on a column-to-column basis in the columns on which the pixels are arranged, but adopts 2H1V-CCDI driving in which the polarity is inverted at intervals of two rows in the row direction.

The 2H1V-CCDI driving has the advantage of being capable of further reducing decreased power consumption achieved by the 1H1V-CCDI driving. That is, although the 1H1V inversion involves inverting the polarity of the video signal (or reverse transition preventing signal) supplied to each signal line S at intervals of one horizontal period (1H), the 2H1V inversion involves inverting the polarity of the video signal at intervals of two horizontal periods (2H). This reduces the frequency of the charge and discharge of the signal lines to half, thus decreasing power consumption.

First, the layout of the auxiliary capacitances Cst in the 2H1V-CCDI driving will be described. In the 1H1V-CCDI driving, whether the auxiliary capacitance Cst is located above or below the pixel electrode depends on whether the corresponding column is the odd-number-th (ODD) or the even-number-th (EVEN). However, in the 2H1V-CCDI driving, the polarity pattern for the pixels PX is predetermined, and the appropriate layout of the auxiliary capacitances Cst is determined based on the polarity pattern.

The following description is based on FIG. 5A showing a positive frame during the up-down scan (in which the scan direction control signal UD is at the H level). First, driving corresponding to the positive frame in FIG. 3A is carried out, and thus FIG. 5A shows the waveforms of the gate signal SG, the Cs signal SCs, and the Cs polarity control signal FR, and the polarity of each Cs signal SCs which are similar to those which are shown in FIG. 3A. That is, the waveform of the positive frame in FIG. 5A is the same as the waveform of the positive frame shown in FIG. 4A.

In this case, the polarities of the Cs signal SCs1, Cs signal SCs2, Cs signal SCs3, Cs signal SCs4, Cs signal SCs5, Cs signal SCs6, . . . are positive, negative, positive, negative, positive, negative, . . . , respectively.

It is assumed that as shown in a pixel layout in the left of FIG. 5A, the superimposed voltage from the Cs signal is provided in a 2H1V inversion pattern in which for example, on the odd-number-th (ODD) column, the display polarities of pixels PX(O1), PX(O2), PX(O3), PX(O4), PX(O5), . . . are positive, positive, negative, negative, positive, . . . , respectively, and in which on the even-number-th (EVEN) column, the display polarities of pixels PX(E1), PX(E2), PX(E3), PX(E4), PX(E5), . . . are negative, negative, positive, positive, negative, . . . , respectively,

First, on the row of the gate line G1, a positive superimposed voltage is provided to the pixel PX(O1), and a negative superimposed voltage is provided to the pixel (E1). Thus, the pixel PX(O1) may form an auxiliary capacitance Cst with the upper auxiliary capacitance line Cs1 (positive polarity). The pixel PX(E1) may form an auxiliary capacitance Cst with the lower auxiliary capacitance line Cs2 (negative polarity).

On the row of the gate line G2, a positive superimposed voltage is provided to the pixel PX(O2), and a negative superimposed voltage is provided to the pixel (E2). Thus, the pixel PX(O2) may form an auxiliary capacitance Cst with the lower auxiliary capacitance line Cs3 (positive polarity). The pixel PX(E2) may form an auxiliary capacitance Cst with the upper auxiliary capacitance line Cs2 (negative polarity).

On the row of the gate line G3, a negative superimposed voltage is provided to the pixel PX(O3), and a positive superimposed voltage is provided to the pixel (E3). Thus, the pixel PX(O3) may form an auxiliary capacitance Cst with the lower auxiliary capacitance line Cs4 (negative polarity). The pixel PX(E3) may form an auxiliary capacitance Cst with the upper auxiliary capacitance line Cs3 (positive polarity).

On the row of the gate line G4, a negative superimposed voltage is provided to the pixel PX(O4), and a positive superimposed voltage is provided to the pixel (E4). Thus, the pixel PX(O4) may form an auxiliary capacitance Cst with the upper auxiliary capacitance line Cs4 (negative polarity). The pixel PX(E4) may form an auxiliary capacitance Cst with the lower auxiliary capacitance line Cs5 (positive polarity).

On the row of the gate line G5, a positive superimposed voltage is provided to the pixel PX(O5), and a negative superimposed voltage is provided to the pixel (E5). Thus, the pixel PX(O5) may form an auxiliary capacitance Cst with the upper auxiliary capacitance line Cs5 (positive polarity). The pixel PX(E5) may form an auxiliary capacitance Cst with the lower auxiliary capacitance line Cs5 (negative polarity).

The auxiliary capacitances Cst can be similarly determined for the row of the gate line G6, the row of the gate line G7, . . . . The layout of the auxiliary capacitances Cst thus obtained are in a repeated pattern with a period of four rows which corresponds to the pixel polarity pattern.

The polarity pattern of the source output is also shown above the waveform of the Cs polarity control signal FR. The polarity pattern of the source output may be determined so as to match the superimposed voltage polarity pattern of the pixels PX, and comprises four horizontal periods.

For a negative frame in FIG. 5B, driving is carried out so as to reverse the polarity of the Cs signal SCs with respect to the layout of the auxiliary capacitances Cst determined as described above. Thus, both the display polarity of the pixel PX and the polarity of the source output are inverted with respect to the positive frame.

FIG. 5C and FIG. 5J are a layout of the auxiliary capacitances Cst and a timing chart for a down-up scan (in which the scan direction control signal UD is at the L level).

Now, an example for a down-up scan (in which the scan direction control signal UD is at the L level) will be described with reference to FIG. 5C and FIG. 5D. Here, by way of example, M is 800. The basic concept is similar to that for the 1H1V-CCDI driving except that the waveforms of the gate signal SG and the Cs signal SCs are changed as described below compared to the waveforms of the gate signal SG and the Cs signal SCs in FIG. 5A and FIG. 5B.

That is, a comparison between the case of the up-down scan shown in FIG. 5A and FIG. 5B and the case of the down-up scan shown in FIG. 5C and FIG. 5D indicates that the scan direction control signal UD, the clock signal CLK1, and the clock signal CLK2 are each inverted between these cases. Furthermore, the shift register P(k) in the up-down scan corresponds to the shift register P(M+1−k) (k=−1, 0, 1, . . . , M+2) in the down-up scan. The shift register Q(j) in the up-down scan corresponds to the shift register Q(j+2−k) (j=1, 2, . . . , M+1) in the down-up scan.

As a result, the scanning direction is inverted in the vertical direction. The gate line G(k) in the up-down scan corresponds to the gate line G(M+1−k) (k=−1, 0, 1, . . . , M+2) in the down-up scan. The auxiliary capacitance line Cs(j) in the up-down scan corresponds to the auxiliary capacitance line Cs(M+2−j) (j=1, 2, . . . , M+1) in the down-up scan.

It should be noted that in the 2H1V-CCDI driving, the layout of the auxiliary capacitances Cst has a repeated pattern with a period of four rows. That is, the layouts of the auxiliary capacitance Cst on the row of the gate line G797, the row of the gate line G798, the row of the gate line G799, and the row of the gate line G800 are the same as the layouts of the auxiliary capacitance Cst on the row of the gate line G1, the row of the gate line G2, the row of the gate line G3, and the row of the gate line G4, respectively. That is, the layout of the auxiliary capacitances Cst is the same for the rows of the pixels PX for which the remainder (1, 2, 3, and 0) of the division of the row number by 4 is the same.

As described with reference to FIG. 4C and FIG. 4D for the 1H1V-CCDI driving, the layout of the pixels in FIG. 5C and FIG. 5D is drawn upside down compared to the layout of the pixels in FIG. 5A and FIG. 5B in the vertical direction. The same procedure as that which is described with reference to FIG. 4A and FIG. 4B for the 1H1V-CCDI driving may be used to determine the polarity of the superimposed voltage to be provided to each pixel electrodes PE and the polarity of the source output to be provided in association with the polarity of the superimposed voltage.

The case of a positive frame will be described in connection with, for example, the gate line G800. During a horizontal period (1H) following a change of the gate signal SG800 to the H level, the Cs signal SCs801 from the auxiliary capacitance line Cs801 located below the gate line SG800 (in FIG. 50 and FIG. 5D, above the gate line SG800) changes from the L level to the H level (the Cs signal SCs801 has the “positive polarity”). Moreover, during the next horizontal period (1H), the Cs signal SCs800 from the auxiliary capacitance line Cs800 located above the gate line SG800 (in FIG. 5C and FIG. 5D, below the gate line SG800) changes from the H level to the L level (the Cs signal SCs800 has the “negative polarity”).

This means as follows. For a pixel PX(E800) with the auxiliary capacitance Cst connected to the auxiliary capacitance line Cs801 located below the pixel electrode PE, a positive superimposed voltage resulting from capacitive coupling is applied to the pixel potential via the auxiliary capacitance Cst after the relevant signal is written to the pixel electrode PE. For a pixel PX(O800) with the auxiliary capacitance Cst connected to auxiliary capacitance line Cs801 located above the pixel electrode PE, a negative superimposed voltage resulting from capacitive coupling is applied to the pixel potential via the auxiliary capacitance Cst after the relevant signal is written to the pixel electrode PE.

Thus, during a horizontal period (1H) when the gate signal SG800 is at the H level, the source output to the signal line S on the odd-number-th (ODD) column needs to have the negative polarity. Furthermore, the source output to the signal line S on the even-number-th (EVEN) column needs to have the positive polarity.

Sequential application of a similar concept to the rows of the gate lines G799, the gate line G798, . . . allows determination of the polarity of the superimposed voltage to be provided to the pixel electrodes PE on each row and the polarity of the source output to be provided in association with the polarity of the superimposed voltage. The thus determined polarity of the superimposed voltage is shown on each pixel PX. Furthermore, the thus determined polarity of the source output is shown above the waveform of the Cs polarity control signal FR.

Furthermore, in a negative frame, the polarity of the Cs signal SCs is inverted with respect to the positive frame. Thus, the polarity of the superimposed voltage to be provided to each pixel electrode PE and the polarity of the source output to be provided in association with the polarity of the superimposed voltage are also inverted with respect to the positive frame.

In the 2H1V-CCDI driving, since the layout of the auxiliary capacitances Cst has the repeated pattern with a period of four rows as described above, the polarity of the superimposed voltage and the polarity of the source output to be provided in association with the polarity of the superimposed voltage during a down-up scan vary depending on the remainder of the division of the number of rows M in the display area ACT by 4. Results similar to those in the case of FIGS. 5C and 5D are obtained only when M is a multiple of four (M is represented by 4p where p is an integer).

FIG. 5E and FIG. 5F show a driving waveform diagram and a layout of the auxiliary capacitances Cst for a down-up scan in which M=4p+1 (for example, M=801). The waveforms of the gate signal SG and the Cs signal SCs are changed as described below compared to the waveforms of the gate signal SG and the Cs signal SCs in FIG. 5A and FIG. 5B.

That is, a comparison between the case of the up-down scan shown in FIG. 5A and FIG. 5B and the case of the down-up scan shown in FIG. 5E and FIG. 5F indicates that the scan direction control signal UD, the clock signal CLK1, and the clock signal CLK2 are each inverted between these cases. Furthermore, the shift register P(k) in the up-down scan corresponds to the shift register P(M+1−k) (k=−1, 0, 1, . . . , M+2) in the down-up scan. The shift register Q(j) in the up-down scan corresponds to the shift register Q(j+2−k) (j=1, 2, . . . , M+1) in the down-up scan.

As a result, the scanning direction is inverted in the vertical direction. The gate line G(k) in the up-down scan corresponds to the gate line G(M+1−k) (k=−1, 0, 1, . . . , M+2) in the down-up scan. The auxiliary capacitance line Cs(j) in the up-down scan corresponds to the auxiliary capacitance line Cs(M+2−j) (j=1, 2, . . . , M+1) in the down-up scan.

The layout of the auxiliary capacitances Cst on the row of the gate line G801 is the same as the layout of the auxiliary capacitances Cst on the row of the gate line G1. The row of the gate line G800, the row of the gate line G799, the row of the gate line G798, . . . , and the row of the gate line G1 each have the same layout of the auxiliary capacitances Cst as that in FIG. 5C and FIG. 5D.

FIG. 5E and FIG. 5F show pixel layouts in which the gate lines are arranged in the following order from top to bottom: G801, G800, G799, . . . and which are drawn upside down compared to FIG. 5A and FIG. 5B. Thus, the polarity of the auxiliary capacitance line Cs to which the auxiliary capacitance Cst for the pixel PX is connected is also inverted in the vertical direction.

The same procedure as that which is described with reference to FIG. 4A and FIG. 4B for the 1H1V-CCDI driving may be used to determine the polarity of the superimposed voltage to be provided to each pixel electrodes PE and the polarity of the source output to be provided in association with the polarity of the superimposed voltage.

The case of a positive frame will be described in connection with, for example, the gate line G801. During a horizontal period (1H) following a change of the gate signal SG801 to the H level, a Cs signal SCs802 from an auxiliary capacitance line Cs802 located below the gate line SG801 (in FIG. 5E and FIG. 5F, above the gate line SG801) changes from the L level to the H level (the Cs signal SCs 802 has the “positive polarity”). Moreover, during the next horizontal period (1H), the Cs signal SCs801 from the auxiliary capacitance line Cs801 located above the gate line SG801 (in FIG. 5E and FIG. 5F, below the gate line SG801) changes from the H level to the L level (the Cs signal SCs 801 has the “negative polarity”).

This means as follows. For a pixel PX(E801) with the auxiliary capacitance Cst connected to the auxiliary capacitance line Cs802 located below the pixel electrode PE, a positive superimposed voltage resulting from capacitive coupling is applied to the pixel potential via the auxiliary capacitance Cst after the relevant signal is written to the pixel electrode PE. For a pixel PX(O801) with the auxiliary capacitance Cst connected to auxiliary capacitance line Cs801 located above the pixel electrode PE, a negative superimposed voltage resulting from capacitive coupling is applied to the pixel potential via the auxiliary capacitance Cst after the relevant signal is written to the pixel electrode PE.

Thus, during a horizontal period (1H) when the gate signal SG801 is at the H level, the source output to the signal line S on the odd-number-th (ODD) column needs to have the negative polarity. Furthermore, the source output to the signal line S on the even-number-th (EVEN) column needs to have the positive polarity.

Sequential application of a similar concept to the rows of the gate lines G800, the gate line G799, . . . allows determination of the polarity of the superimposed voltage to be provided to the pixel electrodes PE on each row and the polarity of the source output to be provided in association with the polarity of the superimposed voltage. The thus determined polarity of the superimposed voltage is shown on each pixel PX. Furthermore, the thus determined polarity of the source output is shown above the waveform of the Cs polarity control signal FR.

Furthermore, in a negative frame, the polarity of the Cs signal SCs is inverted with respect to the positive frame. Thus, the polarity of the superimposed voltage to be provided to each pixel electrode PE and the polarity of the source output to be provided in association with the polarity of the superimposed voltage are also inverted with respect to the positive frame.

FIG. 5G and FIG. 5H show a driving waveform diagram and a layout of the auxiliary capacitances Cst of pixels for a down-up scan in which M=4p+2 (for example, M=802). The waveforms of the gate signal SG and the Cs signal SCs are changed as described below compared to the waveforms of the gate signal SG and the Cs signal SCs in FIG. 5A and FIG. 5B.

That is, a comparison between the case of the up-down scan shown in FIG. 5A and FIG. 5B and the case of the down-up scan shown in FIG. 5G and FIG. 5H indicates that the scan direction control signal UD, the clock signal CLK1, and the clock signal CLK2 are each inverted between these cases. Furthermore, the shift register P(k) in the up-down scan corresponds to the shift register P(M+1−k) (k=−1, 0, 1, . . . , M+2) in the down-up scan. The shift register Q(j) in the up-down scan corresponds to the shift register Q(j+2−k) (j=1, 2, . . . , M+1) in the down-up scan.

As a result, the scanning direction is inverted in the vertical direction. The gate line G(k) in the up-down scan corresponds to the gate line G(M+1−k) (k=−1, 0, 1, . . . , M+2) in the down-up scan. The auxiliary capacitance line Cs(j) in the up-down scan corresponds to the auxiliary capacitance line Cs(M+2−j) (j=1, 2, . . . , M+1) in the down-up scan.

The layout of the auxiliary capacitances Cst on the row of a gate line G802 is the same as the layout of the auxiliary capacitances Cst on the row of the gate line G2. The row of the gate line G802, the row of the gate line G801, the row of the gate line G800, . . . , and the row of the gate line G1 each have the same layout of the auxiliary capacitances Cst as that in FIG. 5E and FIG. 5F.

FIG. 5G and FIG. 5H show pixel layouts in which the gate lines are arranged in the following order from top to bottom: G802, G801, G800, . . . and which are drawn upside down compared to FIG. 5A and FIG. 5B. Thus, the polarity of the auxiliary capacitance line Cs to which the auxiliary capacitance Cst for the pixel PX is connected is also inverted in the vertical direction.

The same procedure as that which is described with reference to FIG. 4A and FIG. 4B for the 1H1V-CCDI driving may be used to determine the polarity of the superimposed voltage to be provided to each pixel electrodes PE and the polarity of the source output to be provided in association with the polarity of the superimposed voltage.

The case of a positive frame will be described in connection with, for example, the gate line G802. During a horizontal period (1H) following a change of the gate signal SG802 to the H level, a Cs signal SCs803 from an auxiliary capacitance line Cs803 located below the gate line SG802 (in FIG. 5G and FIG. 5H, above the gate line SG802) changes from the L level to the H level (the Cs signal SCs803 has the “positive polarity”). Moreover, during the next horizontal period (1H), the Cs signal SCs802 from the auxiliary capacitance line Cs802 located above the gate line SG802 (in FIG. 5G and FIG. 5H, below the gate line SG802) changes from the H level to the L level (the Cs signal SCs802 has the “negative polarity”).

This means as follows. For a pixel PX(O802) with the auxiliary capacitance Cst connected to the auxiliary capacitance line Cs803 located below the pixel electrode PE, a positive superimposed voltage resulting from capacitive coupling is applied to the pixel potential via the auxiliary capacitance Cst after the relevant signal is written to the pixel electrode PE. For a pixel PX(E802) with the auxiliary capacitance Cst connected to auxiliary capacitance line Cs802 located above the pixel electrode PE, a negative superimposed voltage resulting from capacitive coupling is applied to the pixel potential via the auxiliary capacitance Cst after the relevant signal is written to the pixel electrode PE.

Thus, during a horizontal period (1H) when the gate signal SG802 is at the H level, the source output to the signal line S on the odd-number-th (ODD) column needs to have the positive polarity. Furthermore, the source output to the signal line S on the even-number-th (EVEN) column needs to have the negative polarity.

Sequential application of a similar concept to the rows of the gate lines G801, the gate line G800, . . . allows determination of the polarity of the superimposed voltage to be provided to the pixel electrodes PE on each row and the polarity of the source output to be provided in association with the polarity of the superimposed voltage. The thus determined polarity of the superimposed voltage is shown on each pixel PX. Furthermore, the thus determined polarity of the source output is shown above the waveform of the Cs polarity control signal FR.

Furthermore, in a negative frame, the polarity of the Cs signal SCs is inverted with respect to the positive frame. Thus, the polarity of the superimposed voltage to be provided to each pixel electrode PE and the polarity of the source output to be provided in association with the polarity of the superimposed voltage are also inverted with respect to the positive frame.

FIG. 5I and FIG. 5J show a driving waveform diagram and a layout of the auxiliary capacitances Cst of the pixels for a down-up scan in which M=4p+3 (for example, M=803). The waveforms of the gate signal SG and the Cs signal SCs are changed as described below compared to the waveforms of the gate signal SG and the Cs signal SCs in FIG. 5A and FIG. 5B.

That is, a comparison between the case of the up-down scan shown in FIG. 5A and FIG. 5B and the case of the down-up scan shown in FIG. 5I and FIG. 5J indicates that the scan direction control signal UD, the clock signal CLK1, and the clock signal CLK2 are each inverted between these cases. Furthermore, the shift register P(k) in the up-down scan corresponds to the shift register P(M+1−k) (k=−1, 0, 1, . . . , M+2) in the down-up scan. The shift register Q(j) in the up-down scan corresponds to the shift register Q(j+2−k) (j=1, 2, . . . , M+1) in the down-up scan.

As a result, the scanning direction is inverted in the vertical direction. The gate line G(k) in the up-down scan corresponds to the gate line G(M+1−k) (k=−1, 0, 1, . . . , M+2) in the down-up scan. The auxiliary capacitance line Cs(j) in the up-down scan corresponds to the auxiliary capacitance line Cs(M+2−j) (j=1, 2, . . . , M+1) in the down-up scan.

The layout of the auxiliary capacitances Cst on the row of a gate line G803 is the same as the layout of the auxiliary capacitances Cst on the row of the gate line G3. Of course, the row of the gate line G803, the row of the gate line G802, the row of the gate line G802, . . . , and the row of the gate line G1 each have the same layout of the⁻auxiliary capacitances Cst as that in FIG. 5D.

In addition, FIG. 5I and FIG. 5J show pixel layouts in which the gate lines are arranged in the following order from top to bottom: G802, G801, G800, . . . and which are drawn upside down compared to FIG. 5A and FIG. 5B. Thus, the polarity of the auxiliary capacitance line Cs to which the auxiliary capacitance Cst for the pixel PX is connected is also inverted in the vertical direction.

The same procedure as that which is described with reference to FIG. 4A and FIG. 4B for the 1H1V-CCDI driving may be used to determine the polarity of the superimposed voltage to be provided to each pixel electrodes PE and the polarity of the source output to be provided in association with the polarity of the superimposed voltage.

The case of a positive frame will be described in connection with, for example, the gate line G803. During a horizontal period (1H) following a change of the gate signal SG803 to the H level, a Cs signal SCs804 from an auxiliary capacitance line Cs804 located below the gate line SG803 (in FIG. 5I and FIG. 5J, above the gate line SG803) changes from the L level to the H level (the Cs signal SCs 804 has the “positive polarity”). Moreover, during the next horizontal period (1H), the Cs signal SCs803 from the auxiliary capacitance line Cs803 located above the gate line SG803 (in FIG. 5I and FIG. 5J, below the gate line SG803) changes from the H level to the L level (the Cs signal SCs 803 has the “negative polarity”).

This means as follows. For a pixel PX(O803) with the auxiliary capacitance Cst connected to the auxiliary capacitance line Cs804 located below the pixel electrode PE, a positive superimposed voltage resulting from capacitive coupling is applied to the pixel potential via the auxiliary capacitance Cst after the relevant signal is written to the pixel electrode PE. For a pixel PX(E803) with the auxiliary capacitance Cst connected to auxiliary capacitance line Cs803 located above the pixel electrode PE, a negative superimposed voltage resulting from capacitive coupling is applied to the pixel potential via the auxiliary capacitance Cst after the relevant signal is written to the pixel electrode PE.

Thus, during a horizontal period (1H) when the gate signal SG802 is at the H level, the source output to the signal line S on the odd-number-th (ODD) column needs to have the positive polarity. Furthermore, the source output to the signal line S on the even-number-th (EVEN) column needs to have the negative polarity.

Sequential application of a similar concept to the rows of the gate lines G801, the gate line G800, . . . allows determination of the polarity of the superimposed voltage to be provided to the pixel electrodes PE on each row and the polarity of the source output to be provided in association with the polarity of the superimposed voltage. The thus determined polarity of the superimposed voltage is shown on each pixel PX. Furthermore, the thus determined polarity of the source output is shown above the waveform of the Cs polarity control signal FR.

Furthermore, in a negative frame, the polarity of the Cs signal SCs is inverted with respect to the positive frame. Thus, the polarity of the superimposed voltage to be provided to each pixel electrode PE and the polarity of the source output to be provided in association with the polarity of the superimposed voltage are also inverted with respect to the positive frame.

With the results shown in FIG. 5A to FIG. 5J comprehensively considered, conditions required to provide high-quality display based on the 2H1V-CCDI driving are determined to be as follows.

When the polarity of the source output in a frame with a Cs polarity control signal FR (which determines the polarity of the capacitively-coupled superimposed voltage to be provided to each pixel) during an up-down scan is compared with the polarity of the source output in a frame with the same Cs polarity control signal FR during a down-up scan (both frames are positive or negative),

(1) for M=4p: the phase during the down-up scan leads the phase during the up-down scan by 2H (or lags the phase during the up-down scan by 2H),

(2) for M=4p+1: the phase during the down-up scan leads the phase during the up-down scan by 3H (or lags the phase during the up-down scan by 1H),

(3) for M=4p+2: the phase during the down-up scan is the same as the phase during the up-down scan, and

(4) for M=4p+3: the phase during the down-up scan leads the phase during the up-down scan by 1H (or lags the phase during the up-down scan by 3H) (here, H means a horizontal period).

In all the cases other than the case (3) (M=4p+2), the phase during the up-down scan needs to differ from the phase during the down-up direction. Thus, when switching is carried out between the up-down scan and the down-up scan, the control circuit CTR outputs the phases, in units of H, of the polarities of the source output in frames with the same Cs polarity control signal FR in different manners in accordance with the rules in (1), (2), and (4).

As described above, the present embodiment can provide a liquid crystal display device which achieves vertically inverted display as well as high display quality, and a method for driving the liquid crystal display device.

Furthermore, the control circuit can desirably set at least two types of phase relations between the polarities of the source output in frames with the same Cs polarity control signal FR and select one of the phase relations.

Then, the control circuit CTR can deal with a plurality of the cases (1) to (4) rather than a particular one of these cases and thus have improved general versatility. The control circuit CTR can be used for a plurality of types of devices with different numbers of rows in the display area ACT. This advantageously reduces the development costs and manufacturing costs of the display device including the control circuit CTR.

Many liquid crystal display devices have an even number of rows. Thus, the control circuit CTR has sufficiently high general versatility provided that the control circuit CTR can set at least two types of phase relations described above in (1) and (3) for the polarity of the source output.

For example, electronic apparatuses such as cell phones and smartphones in which a liquid crystal display device is mounted mainly have a screen resolution of 480 (columns)×800 (rows) (800 rows correspond to M=4p) or 480 (columns)×854 (rows) (854 rows correspond to M=4p+2). The use of the control circuit CTR adapted for both screen resolution is advantageous.

The 2H1V-CCDI driving has been described with reference to FIG. 5A to FIG. 5J. However, a similar concept is applicable to nH1V-CCDI driving (n is an integer equal to or larger than 3).

Inverting the polarity of the video signal at intervals of n horizontal periods advantageously enables power consumption involved in the charge and discharge of the signal lines to be reduced in proportion to 1/n. However, an excessively large value of n disadvantageously makes horizontal bands of an n-row pitch or line flickers easily perceivable. Thus, for actual display devices, the optimum value of n may be selected with image quality and the required specification of power consumption taken into account.

Also in these cases, application of a concept similar to that of the 2H1V-CCDI driving results in a conclusion that the phase of the polarity of the source polarity needs to vary between the up-down scan and the down-up scan (desirably the repetition period of the layout of the auxiliary capacitances Cst is a period of 2n rows when n is an odd number or is a period of n rows when n is an odd number). Thus, the control circuit CTR is desirably configured to exhibit characteristics as is the case with the 2H1V-CCDI driving.

Now, a liquid crystal display device and a method for driving the liquid crystal display device according to the present invention will be described below with reference to the drawings.

When the value of n is further increased so as to be equal to the total number of rows of the pixels PX, all the pixels in one column have the same polarity. This corresponds to a CC column inversion scheme. In a broad sense, the CC column inversion scheme may be considered to be included in the CCCI driving.

The CC column inversion scheme advantageously requires a reduced amount of power and prevents possible horizontal bands and line flickers. On the other hand, the CC column inversion scheme is disadvantageously likely to case crosstalk. A concept exactly similar to that in the above description is also applicable to the CC column inversion scheme.

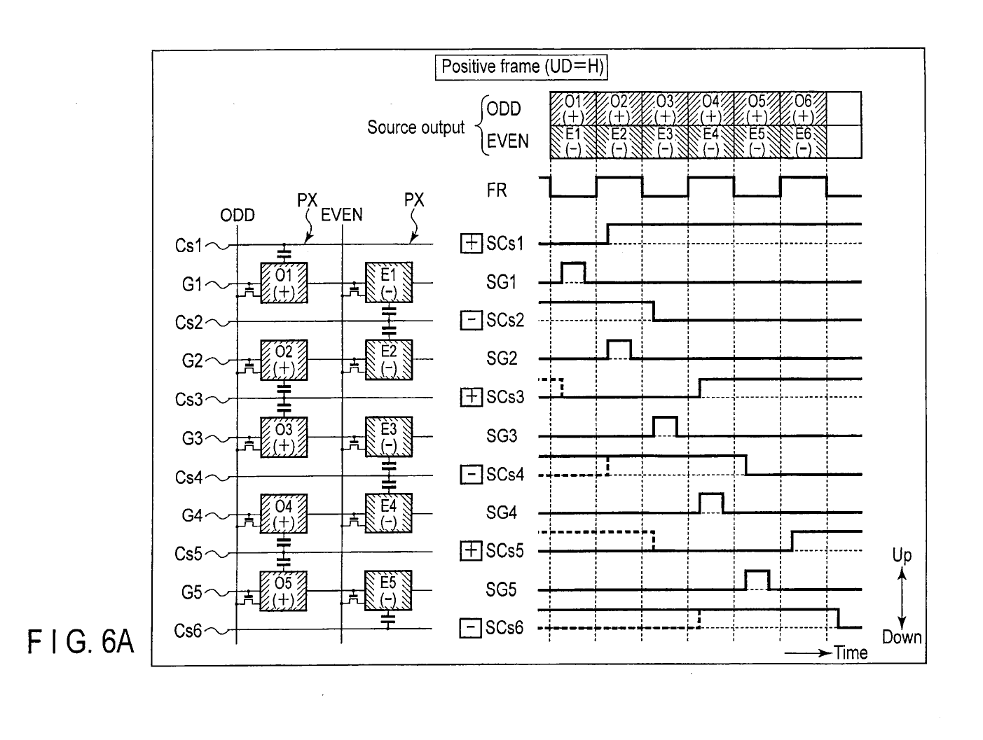

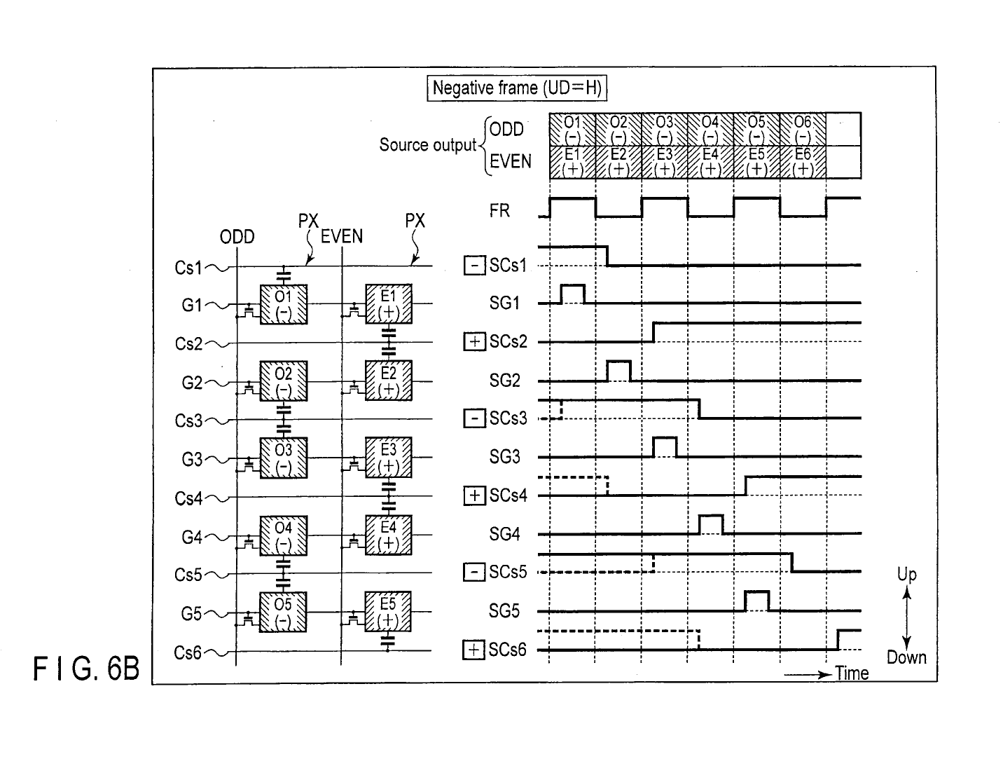

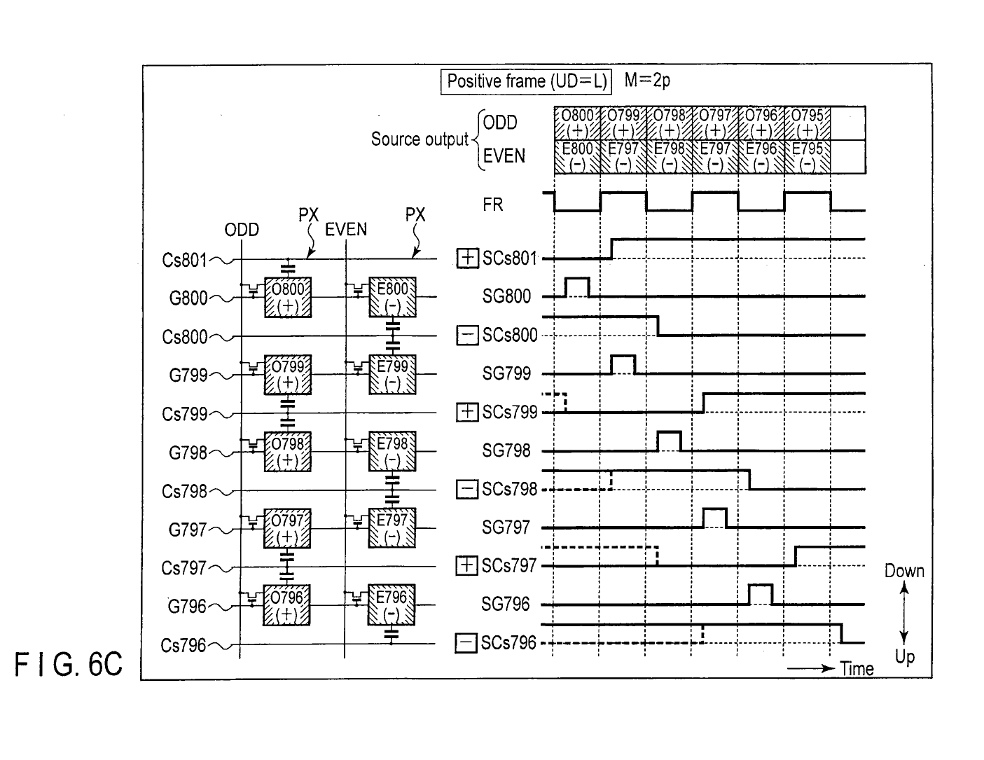

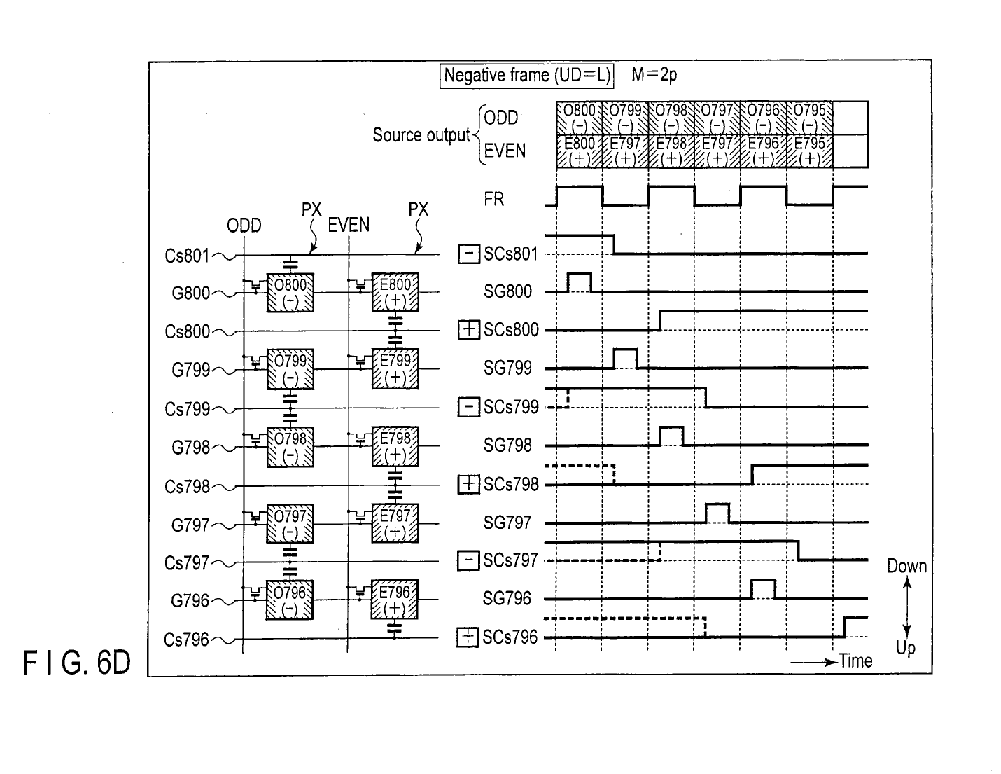

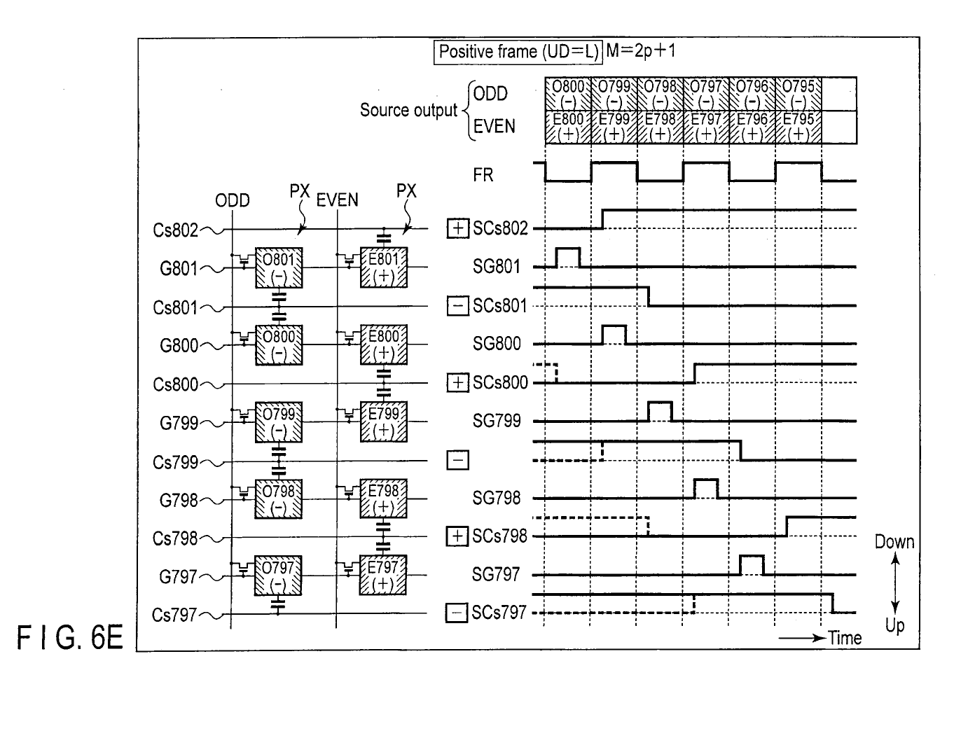

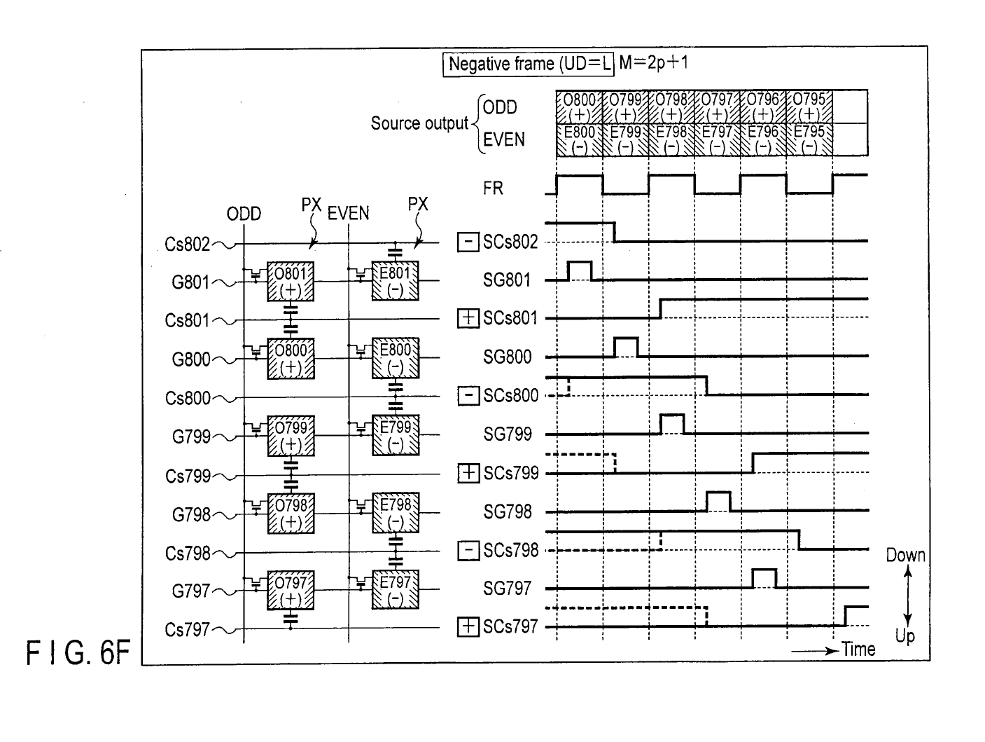

FIG. 6A to FIG. 6F show a layout of the auxiliary capacitances Cst and driving waveforms for a liquid crystal display device that adopts the CC column inversion scheme. Exactly the same concept as that which is described with reference to FIG. 5A to FIG. 5D is applied to the layout of the auxiliary capacitances Cst and the driving waveforms. FIG. 6A and FIG. 6B correspond to an up-down scan (in which the scan direction control signal UD is at the H level). The appropriate layout pattern of the auxiliary capacitances Cst shown in FIG. 6A and FIG. 6B is determined based on the waveforms of the gate signal SG and the Cs signal SCs shown in FIG. 3A and a pixel polarity pattern for column inversion (for example, in a positive frame, the odd-number-th (ODD) column is set to the positive polarity, and the even-number-th (EVEN) column is set to the negative polarity).

The following description is based on FIG. 6A showing a positive frame during the up-down scan (in which the scan direction control signal UD is at the H level). First, driving corresponding to the positive frame in FIG. 3A is carried out, and thus FIG. 6A shows the waveforms of the gate signal SG, the Cs signal SCs, and the Cs polarity control signal FR, and the polarity of each Cs signal SCs which are similar to those which are shown in FIG. 3A. That is, the waveform of the positive frame in FIG. 6A is the same as the waveform of the positive frame shown in FIG. 4A.

In this case, the polarities of the Cs signal SCs1, Cs signal SCs2, Cs signal SCs3, Cs signal SCs4, Cs signal SCs5, Cs signal SCs6, . . . are positive, negative, positive, negative, positive, negative, . . . , respectively.

It is assumed that as shown in a pixel layout in the left of FIG. 6A, the superimposed voltage from the Cs signal is provided in a polarity pattern in which for example, on the odd-number-th (ODD) column, the display polarities of the pixels PX(O1), PX(O2), PX(O3), PX(O4), PX(O5), . . . are positive and in which on the even-number-th (EVEN) column, the display polarities of the pixels PX(E1), PX(E2), PX(E3), PX(E4), PX(E5), . . . are negative.

First, on the row of the gate line G1, a positive superimposed voltage is provided to the pixel PX(O1), and a negative superimposed voltage is provided to the pixel (E1). Thus, the pixel PX(O1) may form an auxiliary capacitance Cst with the upper auxiliary capacitance line Cs1 (positive polarity). The pixel PX(E1) may form an auxiliary capacitance Cst with the lower auxiliary capacitance line Cs2 (negative polarity).

On the row of the gate line G2, a positive superimposed voltage is provided to the pixel PX(O2), and a negative superimposed voltage is provided to the pixel (E2). Thus, the pixel PX(O2) may form an auxiliary capacitance Cst with the lower auxiliary capacitance line Cs3 (positive polarity). The pixel PX(E2) may form an auxiliary capacitance Cst with the upper auxiliary capacitance line Cs2 (negative polarity).

On the row of the gate line G3, a negative superimposed voltage is provided to the pixel PX(O3), and a positive superimposed voltage is provided to the pixel (E3). Thus, the pixel PX(O3) may form an auxiliary capacitance Cst with the upper auxiliary capacitance line Cs4 (negative polarity). The pixel PX(E3) may form an auxiliary capacitance Cst with the lower auxiliary capacitance line Cs3 (positive polarity).

On the row of the gate line G4, a negative superimposed voltage is provided to the pixel PX(O4), and a positive superimposed voltage is provided to the pixel (E4). Thus, the pixel PX(O4) may form an auxiliary capacitance Cst with the lower auxiliary capacitance line Cs4 (negative polarity). The pixel PX(E4) may form an auxiliary capacitance Cst with the upper auxiliary capacitance line Cs5 (positive polarity).

The auxiliary capacitances Cst can be similarly determined for the row of the gate line G5, the row of the gate line G6, . . . . The layout of the auxiliary capacitances Cst thus obtained are in a repeated pattern with a period of two rows in the column direction (the polarity of the source output does not have a period in units of H, and thus the polarity inversion period (two rows) of the auxiliary capacitance lines is reflected in the period of the layout of the auxiliary capacitances Cst). The auxiliary capacitances Cst for the pixels PX on the odd-number-th (ODD) column and even-number-th (EVEN) column arranged on the same row are connected to the different auxiliary capacitance lines Cs. The auxiliary capacitances Cst for the pixels PX on the odd-number-th row and even-number-th row arranged on the same column are connected to the auxiliary capacitance lines Cs on the different sides. The auxiliary capacitance lines Cs with the positive polarity and the auxiliary capacitance lines Cs with the negative polarity are alternately arranged in the row direction.

In the case shown in FIG. 6A and FIG. 6B, the polarity of the source output is, in a positive frame, such that the signal line S on the odd-number-th (ODD) column has the negative polarity, whereas the signal line S on the even-number-th (EVEN) column has the negative polarity. The polarity of the source output is, in a negative frame, such that the signal line S on the odd-number-th (ODD) column has the positive polarity, whereas the signal line S on the even-number-th (EVEN) column has the positive polarity.

FIG. 6C to FIG. 6F are diagrams corresponding to a down-up scan (in which the scan direction control signal UD is at the L level). The layout of the auxiliary capacitances Cst has a repeated pattern with a period of two rows. Thus, FIG. 6C and FIG. 6D show a case where M is an even number (M=2p where p is an integer). FIG. 6E and FIG. 6F show a case where M is an odd number (M=2p+1 where p is an integer). FIG. 6C to FIG. 6F are drawn upside down compared to FIG. 6A and FIG. 6B.

Application of a concept similar to that which is described with reference to FIG. 5C and FIG. 5D allows determination of the polarity of the superimposed voltage to be provided to each pixel electrodes PE and the polarity of the source output to be provided in association with the polarity of the superimposed voltage.

The case of a positive frame shown in FIG. 6C will be described in connection with, for example, the row of the gate line G800. During a horizontal period (1H) following a change of the gate signal SG800 to the H level, the Cs signal SCs801 from the auxiliary capacitance line Cs801 located below the gate line SG800 (in FIG. 6C to FIG. 6F, above the gate line SG800) changes from the L level to the H level (the Cs signal SCs 801 has the “positive polarity”). Moreover, during the next horizontal period (1H), the Cs signal SCs800 from the auxiliary capacitance line Cs800 located above the gate line SG800 (in FIG. 6C to FIG. 6F, below the gate line SG800) changes from the H level to the L level (the Cs signal SCs 800 has the “negative polarity”).

This means as follows. For the pixel PX(O800) with the auxiliary capacitance Cst connected to the auxiliary capacitance line Cs804 located below the pixel electrode PE, a positive superimposed voltage resulting from capacitive coupling is applied to the pixel potential via the auxiliary capacitance Cst after the relevant signal is written to the pixel electrode PE. For the pixel PX(E800) with the auxiliary capacitance Cst connected to auxiliary capacitance line Cs803 located above the pixel electrode PE, a negative superimposed voltage resulting from capacitive coupling is applied to the pixel potential via the auxiliary capacitance Cst after the relevant signal is written to the pixel electrode PE.

Thus, during a horizontal period (1H) when the gate signal SG800 is at the H level, the source output to the signal line S on the odd-number-th (ODD) column needs to have the positive polarity. Furthermore, the source output to the signal line S on the even-number-th (EVEN) column needs to have the negative polarity.

Sequential application of a similar concept to the rows of the gate lines G799, the gate line G798, . allows determination of the polarity of the superimposed voltage to be provided to the pixel electrodes PE on each row and the polarity of the source output to be provided in association with the polarity of the superimposed voltage. The thus determined polarity of the superimposed voltage is shown on each pixel PX. Furthermore, the thus determined polarity of the source output is shown above the waveform of the Cs polarity control signal FR.

Furthermore, in a negative frame shown in FIG. 6D, the polarity of the Cs signal SCs is inverted with respect to the positive frame. Thus, the polarity of the superimposed voltage to be provided to each pixel electrode PE and the polarity of the source output to be provided in association with the polarity of the superimposed voltage are also inverted with respect to the positive frame.

The case of a positive frame shown in FIG. 6E will be described in connection with, for example, the row of the gate line G801. During a horizontal period (1H) following a change of the gate signal SG801 to the H level, the Cs signal SCs802 from the auxiliary capacitance line Cs802 located below the gate line SG801 (in FIG. 6C to FIG. 6F, above the gate line SG801) changes from the L level to the H level (the Cs signal SCs 802 has the “positive polarity”). Moreover, during the next horizontal period (1H), the Cs signal SCs801 from the auxiliary capacitance line Cs801 located above the gate line SG801 (in FIG. 6C to FIG. 6F, below the gate line SG801) changes from the H level to the L level (the Cs signal SCs 801 has the “negative polarity”).

This means as follows. For the pixel PX(E801) with the auxiliary capacitance Cst connected to the auxiliary capacitance line Cs802 located below the pixel electrode PE, a positive superimposed voltage resulting from capacitive coupling is applied to the pixel potential via the auxiliary capacitance Cst after the relevant signal is written to the pixel electrode PE. For the pixel PX(O801) with the auxiliary capacitance Cst connected to auxiliary capacitance line Cs801 located above the pixel electrode PE, a negative superimposed voltage resulting from capacitive coupling is applied to the pixel potential via the auxiliary capacitance Cst after the relevant signal is written to the pixel electrode PE.

Thus, during a horizontal period (1H) when the gate signal SG801 is at the H level, the source output to the signal line S on the odd-number-th (ODD) column needs to have the positive polarity. Furthermore, the source output to the signal line S on the even-number-th (EVEN) column needs to have the negative polarity.

Sequential application of a similar concept to the rows of the gate lines G800, the gate line G799, . . . allows determination of the polarity of the superimposed voltage to be provided to the pixel electrodes PE on each row and the polarity of the source output to be provided in association with the polarity of the superimposed voltage. The thus determined polarity of the superimposed voltage is shown on each pixel PX. Furthermore, the thus determined polarity of the source output is shown above the waveform of the Cs polarity control signal FR.

Furthermore, in a negative frame, the polarity of the Cs signal SCs is inverted with respect to the positive frame. Thus, the polarity of the superimposed voltage to be provided to each pixel electrode PE and the polarity of the source output to be provided in association with the polarity of the superimposed voltage are also inverted with respect to the positive frame.

With the results shown in FIG. 6A to FIG. 6F comprehensively considered, conditions required to provide high-quality display based on the CC column inversion driving are determined to be as follows. When the polarity of the source output in a frame with a Cs polarity control signal FR (which determines the polarity of the capacitively-coupled superimposed voltage to be provided to each pixel) during an up-down scan is compared with the polarity of the source output in a frame with the same Cs polarity control signal FR during a down-up scan,

(5) for M=2p: the phase during the down-up scan is the same as the phase during the up-down scan, and

(6) for M=2p+1: the phase during the down-up scan is opposite to the phase during the up-down scan.

In the case (6), the phase during the up-down scan needs to differ from the phase during the down-up direction. Thus, when switching is carried out between the up-down scan and the down-up scan, the phases, in units of H, of the polarities of the source output in frames with the same FR are desirably output in different manners.

Furthermore, the control circuit can desirably set at least two types of phase relations described in (5) and (6) between the polarities of the source output in frames with the same Cs polarity control signal FR and select one of the phase relations. Then, the control circuit CTR can deal with both cases (5) and (6) rather than a particular one of these cases and thus have improved general versatility. The control circuit CTR can be used for a plurality of types of devices with different numbers of rows in the display area ACT. This advantageously reduces the development costs and manufacturing costs of the display device including the control circuit CTR.

In the case where (3) M=4p+2 according the second embodiment or in the case where (1) M=2p according to the third embodiment, the condition required for normal display is that the phase of the polarity of the source output in a frame with a Cs polarity control signal FR during a down-up scan is the same as the phase of the polarity of the source output in a frame with the Cs polarity control signal FR during an up-down scan. A point common to these cases is that the layout of the auxiliary capacitances Cst is symmetric with respect to the vertical inversion in the display area ACT, that is, more specifically, the layout of the auxiliary capacitances Cst on the row k (k=1, 2, . . . , M−1) is opposite to the layout of the auxiliary capacitances Cst on the row (M+1−k) in the vertical direction.

Only when the layout of the auxiliary capacitances Cst in the display area has such features as described above, the control circuit CTR can provide normal display by outputting signals so that the phase, in units of H, of the polarity of the source output in a frame with a Cs polarity control signal FR during an up-down scan is the same as the phase of the polarity of the source output in a frame with the same Cs polarity control signal FR during a down-up scan.

In the first embodiment to the third embodiment, the example has been described in which the polarity on the odd-number-th (ODD) column is opposite to the polarity on the even-number-th (EVEN) column (1V inversion). However, the present invention is applicable to a case where the polarity is inverted with a period of two columns (nH2V-CCDI driving), a case where the polarity is inverted with a period of three columns (nH3V-CCDI driving), and the like.

In the first embodiment to the third embodiment, the liquid crystal display device in the OCB mode which is adapted for high-speed responses has been described. However, the present invention is applicable to a liquid crystal display device in any other mode (IPS, TN, FFS, VA, or the like).

The present embodiments can provide a liquid crystal display device which enables a reduction in power consumption and which achieves vertically inverted display as well as high display quality, and a method for driving the liquid crystal display device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1-18. (canceled)

19. A liquid crystal display device comprising:
an array substrate comprising pixel electrodes arranged in a matrix, gate lines and auxiliary capacitance lines extending along rows each with the pixel electrodes arranged thereon, signal lines extending along columns each with the pixel electrodes arranged thereon, and a driving circuit configured to drive the gate lines, the signal lines, and the auxiliary capacitance lines;
a counter substrate arranged opposite the array substrate;
a liquid crystal layer held between the array substrate and the counter substrate; and
a control circuit configured to supply a scan direction control signal switching between a first scan in which the gate lines arranged in a direction substantially parallel to a direction in which the signal lines extend and a second scan in which the gate lines are sequentially driven in a second direction opposite to the first direction and a polarity control signal controlling a polarity of a signal supplied to each of the auxiliary capacitance lines, and to be able to control the driving circuit in such a manner that a polarity of a signal supplied to each of the signal lines varies in units of horizontal periods during a frame period when the polarity control signal for the first scan is identical to the polarity control signal for the second scan,
wherein a polarity pattern for a signal supplied to each of the pixel electrodes through the corresponding signal line is nHmV inversion, the n and the m are integers equal to or larger than 1, and the n is equal to or smaller than a number of rows each with the pixel electrodes arranged thereon.

20. The liquid crystal display device according to claim 19, wherein the n is equal to a total number of rows each with the pixel electrodes arranged thereon.

21. The liquid crystal display device according to claim 19, wherein the control circuit is configured to select one of at least two types of phase relations for the polarity of the signal supplied to the signal line during a frame period when the polarity control signal for the first scan is identical to the polarity control signal for the second scan.

22. The liquid crystal display device according to claim 21, wherein when a layout of auxiliary capacitances each allowing a superimposed voltage to be applied to the corresponding pixel electrode is symmetric with respect to a direction in which the gate lines extend, the control circuit controls the driving circuit in such a manner that the polarity of the signal supplied to the signal line remains identical in units of horizontal periods during a frame period when the polarity control signal for the first scan is identical to the polarity control signal for the second scan.

23. The liquid crystal display device according to claim 22, wherein the liquid crystal layer includes a liquid crystal in an OCB mode.

24. The liquid crystal display device according to claim 20, wherein the m is an even number.
